(19) United States
(12) Patent Application Publication
(10) Pub. No.: US 2025/0265738 A1
(43) Pub. Date: Aug. 21, 2025

(54) IMAGE DISPLAY DEVICE, METHOD FOR OPERATING IMAGE DISPLAY DEVICE, AND PROGRAM FOR OPERATING IMAGE DISPLAY DEVICE

(71) Applicant: FUJIFILM Corporation, Tokyo (JP)

(72) Inventors: Erina OGURA, Kanagawa (JP); Shigetoshi ISHIKAWA, Kanagawa (JP); Akiko FUKUSHIMA, Kanagawa (JP); Daiki YOSHIDA, Saitama-shi (JP)

(73) Assignee: FUJIFILM Corporation, Tokyo (JP)

(21) Appl. No.: 19/200,637

(22) Filed: May 6, 2025

Related U.S. Application Data
(63) Continuation of application No. PCT/JP2023/036436, filed on Oct. 5, 2023.

(30) Foreign Application Priority Data
Nov. 10, 2022 (JP) 2022-180167
Jan. 10, 2023 (JP) 2023-001824

(51) Int. Cl. G06T 11/00; G06T 3/40; G06T 7/579

(52) U.S. Cl. CPC G06T 11/00; G06T 7/579; G06T 11/001; G06T 3/40; G06T 2200/24; G06T 2207/20221; G06T 2207/30184; G06T 2207/30204

(57) ABSTRACT

Provided is an image display device including a processor, in which the processor is configured to perform control to display, on a display, a display screen having a display region for a partial image that is a portion of a long image, which is obtained by imaging a structure extending in a first direction with an imaging device and in which a long side direction is along the first direction, and a first index bar which extends in the first direction and indicates a first distance range that is at least a portion of a distance range of the structure in the first direction and on which a capture position mark indicating a capture position of the partial image, which is being displayed in the display region, in the structure is displayed.

### CROSS-REFERENCE TO RELATED APPLICATIONS

This application is a continuation application of International Application No. PCT/JP2023/036436, filed Oct. 5, 2023, the disclosure of which is incorporated herein by reference in its entirety. Further, this application claims priority from Japanese Patent Application No. 2022-180167, filed on Nov. 10, 2022, and Japanese Patent Application No. 2023-001824, filed on Jan. 10, 2023, the disclosures of which are incorporated herein by reference in their entirety.

### BACKGROUND

### 1. Technical Field

The technology of the present disclosure relates to an image display device, a method for operating an image display device, and a program for operating an image display device.

### 2. Description of the Related Art

For example, as described in JP2022-056085A, JP2022-139903A, and JP2017-168077A, a technique has been proposed which extracts deformation occurring in a structure from an image obtained by imaging the structure with an imaging device. The structure is, for example, a so-called infrastructure such as a dam, a bridge, or a tunnel. The deformation is, for example, a crack, peeling, rust, water leakage, or exposure of reinforcing bars.

### SUMMARY

In the technique described in JP2022-056085A, JP2022-139903A, and the like, in a case of a relatively large structure, such as a dam, a bridge, or a tunnel, for example, an image covering the entire structure is obtained by imaging the structure a plurality of times with an imaging device while moving the imaging device, for example, from an entrance to an exit of the tunnel. The image covering the entire structure is a very long image, for example, an image from the entrance to the exit of the tunnel having a total length of 5 km.

In addition, in the technique described in JP2022-056085A, JP2022-139903A, and the like, the image is displayed on a display together with extraction results of the deformation and the like to be viewed by the user. The image displayed in this case is a portion of the image covering the entire structure such as an image in a distance range of 50 m from 2 km to 2.05 km in the tunnel having a total length of 5 km.

In the case of the above-described display form of the image, the user often does not know which portion of the structure the displayed captured image corresponds to. As a result, there is a problem in that it is not possible to specify the position of the structure where the deformation has occurred.

JP2017-168077A discloses an aspect in which an image (referred to as a panoramic image in JP2017-168077A) covering the entire structure and a partial image (referred to as an inspection image in JP2017-168077A) of the image covering the entire structure are displayed on the same screen. Then, as a solution to the above problem, in JP2017-168077A, a frame of the inspection image is displayed on the panoramic image such that a user recognizes which portion of the structure the captured inspection image corresponds to.

However, in JP2017-168077A, since the panoramic image and the inspection image are displayed on the same screen and the frame of the inspection image is displayed on the panoramic image, a screen configuration is cluttered.

An embodiment according to the technology of the present disclosure provides an image display device, a method for operating an image display device, and a program for operating an image display device that enable a user to recognize which portion of a structure a displayed captured image corresponds to with a simple screen configuration.

According to an aspect of the present disclosure, there is provided an image display device including a processor, in which the processor is configured to perform control to display, on a display, a display screen having a display region for a partial image that is a portion of a long image, which is obtained by imaging a structure extending in a first direction with an imaging device and in which a long side direction is along the first direction, and a first index bar which extends in the first direction and indicates a first distance range that is at least a portion of a distance range of the structure in the first direction and on which a capture position mark indicating a capture position of the partial image, which is being displayed in the display region, in the structure is displayed.

Preferably, the processor is configured to: receive a designation of any position of the first index bar; and display the partial image, whose capture position corresponds to the designated position, in the display region.

Preferably, a second index bar that indicates a second distance range wider than the first distance range and indicates which position in the second distance range the first index bar being displayed corresponds to is capable of being displayed.

Preferably, the second distance range is an entire distance range of the structure in the first direction.

Preferably, the partial image is capable of being displayed to be enlarged in the display region, and an auxiliary window indicating which position of the partial image the portion displayed to be enlarged corresponds to is capable of being displayed.

Preferably, an operation portion for inputting an instruction to switch the partial image being displayed in the display region to a partial image adjacent to the partial image being displayed in the display region is provided on the display screen.

Preferably, a portion-of-interest mark indicating a portion of interest in the long image is capable of being displayed on the first index bar.

Preferably, the portion of interest includes at least one of a portion designated by a user or a portion in which a specific object is present.

Preferably, a text memo or a voice memo input by the user is displayed in association with the portion of interest.

Preferably, the portion designated by the user is at least one of a portion designated by an imaging person of the long image during capture of the long image or a portion designated by an inspector of the long image during inspection of the long image.

Preferably, a portion whose partial image is displayed and a portion whose partial image is not displayed are capable of being displayed to be distinguished from each other on the first index bar.

Preferably, a display completion mark indicating the portion whose partial image is displayed is displayed on the first index bar such that the portion whose partial image is displayed and the portion whose partial image is not displayed are displayed to be distinguished from each other.

Preferably, at least one of a brightness, color, or pattern of the first index bar is changed such that the portion whose partial image is displayed and the portion whose partial image is not displayed are displayed to be distinguished from each other.

Preferably, the processor is configured to: receive a designation of an object to be measured in the partial image; and display at least one of a position of the object to be measured in the structure or an actual size of the object to be measured in response to the designation.

Preferably, the long image is an image obtained by combining a plurality of captured images obtained by imaging different portions of the structure with the imaging device a plurality of times along at least the first direction of the first direction and a second direction intersecting the first direction.

Preferably, the plurality of captured images are images obtained by imaging the structure at a plurality of different positions in the first direction while moving the imaging device in the first direction.

Preferably, the imaging device has a plurality of cameras that are arranged along the second direction, and the plurality of captured images are images obtained by imaging the structure with the plurality of cameras. In addition, preferably, the imaging device has a plurality of cameras that are arranged along the first direction, and the plurality of captured images are images obtained by imaging the structure with the plurality of cameras.

Preferably, the imaging device has a plurality of cameras that are arranged along the second direction, the plurality of captured images are images obtained by imaging the structure with the plurality of cameras while moving the imaging device along the first direction, and the long image is an image obtained by combining the plurality of captured images along the first direction and the second direction.

Preferably, the structure is a tunnel, the first direction is a length direction connecting an entrance and an exit of the tunnel, and the second direction is a circumferential direction of the tunnel.

According to another aspect of the present disclosure, there is provided a method for operating an image display device, the method including: performing control to display, on a display, a display screen having a display region for a partial image that is a portion of a long image, which is obtained by imaging a structure extending in a first direction with an imaging device and in which a long side direction is along the first direction, and a first index bar which extends in the first direction and indicates a first distance range that is at least a portion of a distance range of the structure in the first direction and on which a capture position mark indicating a capture position of the partial image, which is being displayed in the display region, in the structure is displayed.

According to still another aspect of the present disclosure, there is provided a program for operating an image display device, the program causing a computer to execute a process including: performing control to display, on a display, a display screen having a display region for a partial image that is a portion of a long image, which is obtained by imaging a structure extending in a first direction with an imaging device and in which a long side direction is along the first direction, and a first index bar which extends in the first direction and indicates a first distance range that is at least a portion of a distance range of the structure in the first direction and on which a capture position mark indicating a capture position of the partial image, which is being displayed in the display region, in the structure is displayed.

According to the technology of the present disclosure, it is possible to provide an image display device, a method for operating an image display device, and a program for operating an image display device that enable a user to recognize which portion of a structure a displayed captured image corresponds to with a simple screen configuration.

### BRIEF DESCRIPTION OF THE DRAWINGS

Exemplary embodiments according to the technique of the present disclosure will be described in detail based on the following figures, wherein:

FIG. 1 is a diagram showing an aspect in which an inner wall surface of a tunnel is imaged with an imaging device;

FIG. 2 is a side view showing the imaging device;

FIG. 3 is a perspective view showing an imaging device main body;

FIG. 4 is a side view showing the imaging device main body;

FIG. 5 is a diagram showing imaging regions of a first imaging unit and a second imaging unit;

FIG. 6 is a diagram showing a structure of a long image;

FIG. 7 is a diagram showing captured image information;

FIG. 8 is a diagram showing an operation screen;

FIG. 9 is a diagram illustrating an operation screen in a case where a portion designation button is selected;

FIG. 10 is a diagram showing during-imaging designated portion information;

FIG. 11 is a diagram showing the imaging device, an information management server, an inspector terminal, and information transmitted from the imaging device to the information management server;

FIG. 12 is a block diagram showing a computer constituting each of the information management server and the inspector terminal;

FIG. 13 is a block diagram showing a processing unit of a CPU of the information management server;

FIG. 14 is a diagram showing during-inspection designated portion information;

FIG. 15 is a diagram showing a process of an extraction unit;

FIG. 16 is a diagram showing extracted image information;

FIG. 17 is a block diagram showing a processing unit of a CPU of the inspector terminal;

FIG. 18 is a diagram showing a bird's-eye view screen;

FIG. 19 is a diagram showing the bird's-eye view screen;

FIG. 20 is a diagram showing a partial index bar of the bird's-eye view screen;

FIG. 21 is a diagram showing an aspect in which a text memo is displayed in association with a during-imaging designated portion mark;

FIG. 22 is a diagram showing an aspect in which the text memo is displayed in association with a during-inspection designated portion mark;

FIG. 23 is a diagram illustrating a partial image display screen;

FIG. 24 is a diagram showing the partial index bar of the partial image display screen;

FIG. 25 is a diagram showing a process of receiving designation of any position of the partial index bar and displaying a partial image whose capture position corresponds to the designated position in a display region;

FIG. 26 is a diagram showing an operation button group;

FIG. 27 is a diagram showing a case where the partial image is displayed to be enlarged;

FIG. 28 is a diagram showing a case where an extracted image is displayed to be superimposed on the partial image;

FIG. 29 is a diagram showing an aspect in which the position and actual size of an object to be measured designated in the partial image are displayed;

FIG. 30 is a diagram showing an aspect in which the position and actual size of the object to be measured designated in the partial image are displayed;

FIG. 31 is a diagram showing a process of switching a partial image being displayed in the display region to a partial image adjacent to the partial image being displayed in the display region;

FIG. 32 is a diagram showing a process of switching the partial image being displayed in the display region to a partial image adjacent to the partial image being displayed in the display region;

FIG. 33 is a flowchart showing a processing procedure of the information management server and the inspector terminal;

FIG. 34 is a diagram showing another example in which a portion in which the partial image is displayed and a portion in which the partial image is not displayed are displayed to be distinguished from each other;

FIG. 35 is a diagram showing an example in which the during-imaging designated portion mark and the like are displayed on a whole index bar; and

FIG. 36 is a diagram showing another example of the during-imaging designated portion information.

### DETAILED DESCRIPTION

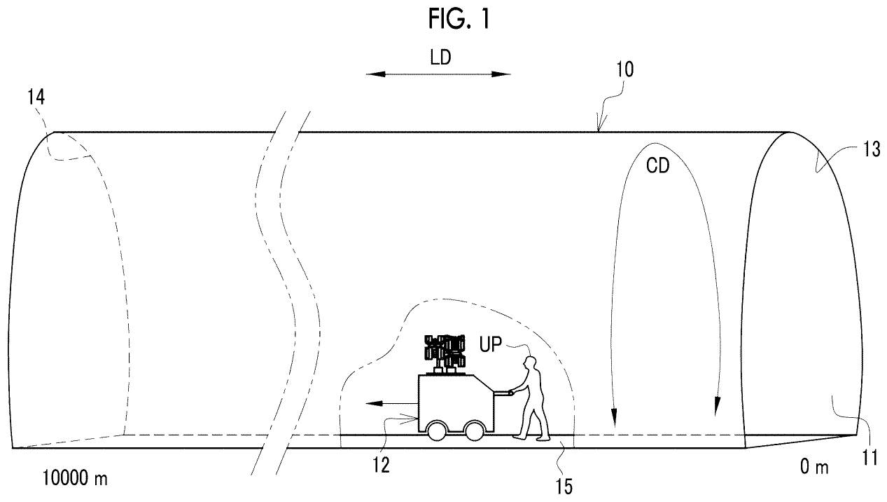

FIG. 1 shows an aspect in which an imaging person UP images an inner wall surface 11 of a tunnel 10 along a circumferential direction CD using an imaging device 12. The tunnel 10 has an entrance 13 and an exit 14 and extends in a length direction LD connecting the entrance 13 and the exit 14. A length from the entrance 13 to the exit 14, that is, a total length of the tunnel 10 is, for example, 10000 m. The imaging person UP moves the imaging device 12 from the entrance 13 to the exit 14, for example, along a center line of a road surface 15 to move the imaging device 12 along the length direction LD. The tunnel 10 is an example of a “structure” according to the technology of the present disclosure. The length direction LD is an example of a “first direction” according to the technology of the present disclosure. The circumferential direction CD is an example of a “second direction” according to the technology of the present disclosure. The imaging person UP is an example of a “user” according to the technology of the present disclosure.

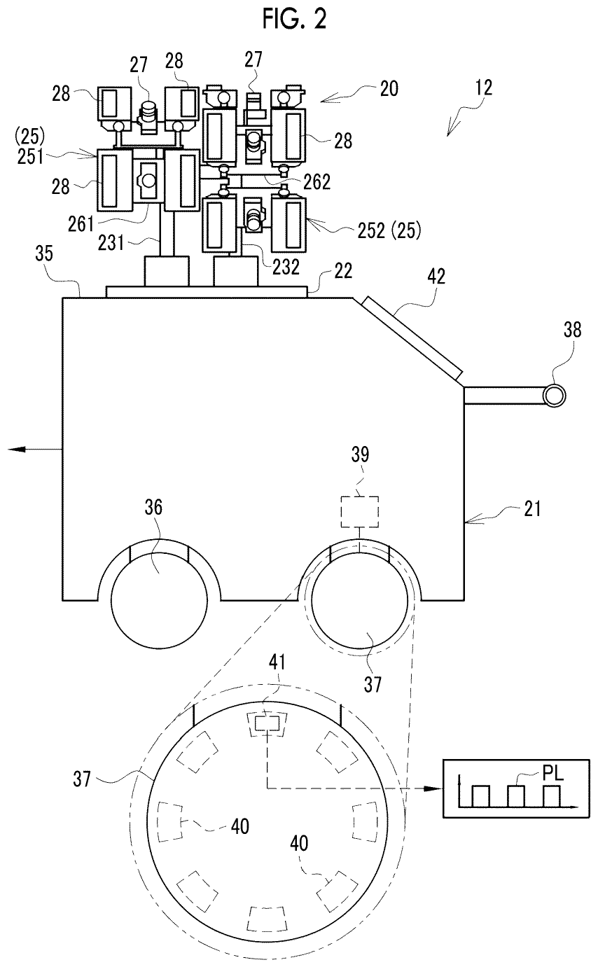

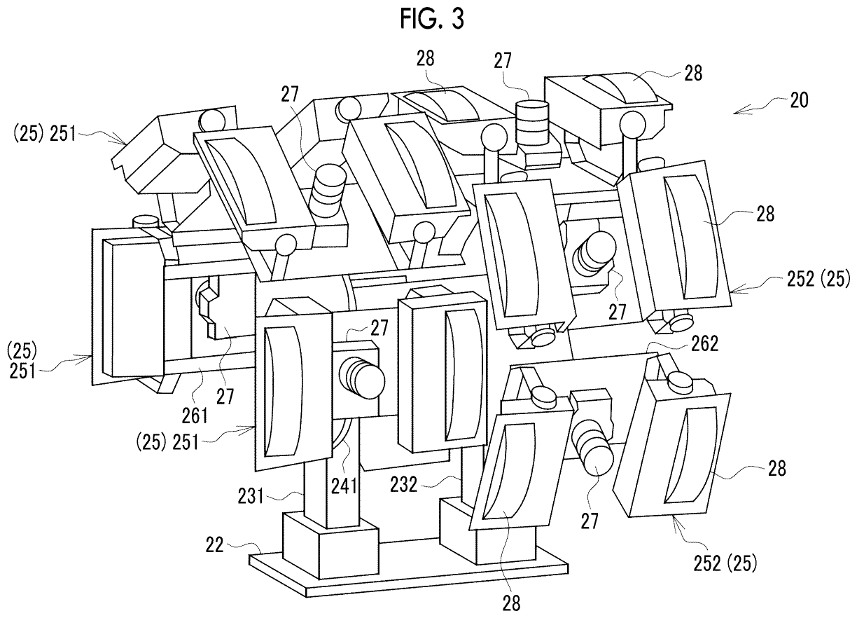

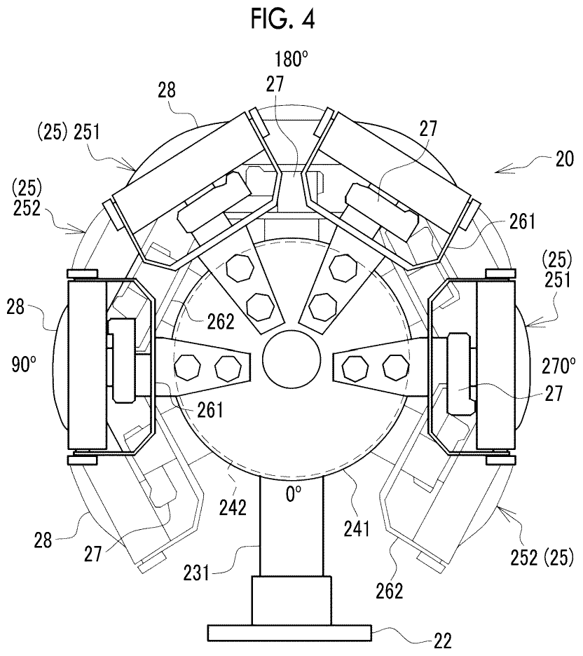

As shown in FIG. 2 as an example, the imaging device 12 includes an imaging device main body 20 and a carriage 21 on which the imaging device main body 20 is mounted. As shown in FIGS. 3 and 4, the imaging device main body 20 includes a base 22, a first support 231, a second support 232, a first attachment plate 241, a second attachment plate 242, a first imaging unit 251, and a second imaging unit 252.

The base 22 has a rectangular plate shape and is attached to the carriage 21 by screwing or the like. The first support 231 and the second support 232 are rectangular prisms that extend from the base 22 in a vertical direction. The first attachment plate 241 and the second attachment plate 242 have a disk shape, and the centers thereof are fixed to end portions of the first support 231 and the second support 232 that are opposite to the base 22.

Four first imaging units 251 are attached to the first attachment plate 241 through first attachment tools 261. In addition, five second imaging units 252 are attached to the second attachment plate 242 through second attachment tools 262. That is, the imaging device main body 20 includes a total of nine imaging units 25.

In a case where the angle of a lower portion of each of the first attachment plate 241 and the second attachment plate 242 is 0° and the angles of left, upper, and right portions of each of the first attachment plate 241 and the second attachment plate 242 in a clockwise direction from the lower portion are 90°, 180°, and 270°, respectively (see FIG. 4), the first imaging units 251 are disposed at positions of 90°, 150°, 210°, and 270°. In addition, the second imaging units 252 are disposed at positions of 60°, 120°, 180°, 240°, and 300°. That is, both the first imaging units 251 and the second imaging units 252 are disposed at angular intervals of 60°. In addition, a total of nine imaging units 25 including the first imaging units 251 and the second imaging units 252 are disposed at angular intervals of 30°. The number of imaging units 25 is not limited to nine shown in the example. The number of imaging units 25 may be one or more than nine.

Each of the first imaging unit 251 and the second imaging unit 252 includes one camera 27 and two illumination lamps 28 that are disposed at symmetrical positions with the camera 27 interposed therebetween. The camera 27 is, for example, a high-performance single-lens reflex camera that is equipped with an imaging element having 20 million pixels or more and has a distance measurement function of measuring a distance to an object, a shake correction function of correcting a shake, and the like. The illumination lamp 28 is, for example, a light-emitting diode (LED) that has a light distribution angle exceeding an imaging angle of view of the camera 27.

In a case where the imaging device main body 20 is mounted on the carriage 21, the first support 231, the first attachment plate 241, and thus the first imaging unit 251 are located on the front side of the carriage 21 in a traveling direction. In addition, the second support 232, the second attachment plate 242, and thus the second imaging unit 252 are located on the rear side of the carriage 21 in the traveling direction. Therefore, the cameras 27 of the first imaging unit 251 and the second imaging unit 252 are disposed along the traveling direction of the carriage 21. The traveling direction of the carriage 21 is along the length direction LD of the tunnel 10 as shown in FIG. 1. Therefore, it can be said that the cameras 27 are disposed along the length direction LD. In addition, the cameras 27 are attached to surround the disk-shaped first attachment plate 241 and second attachment plate 242, and the carriage 21 travels such that a direction normal to the first attachment plate 241 and the second attachment plate 242 is along the length direction LD. For these reasons, it can be said that the cameras 27 are disposed along the circumferential direction CD. Further, three or more cameras 27 may be disposed along the length direction LD. In addition, a plurality of cameras 27 may not be disposed along the length direction LD. Similarly, a plurality of cameras 27 may not be disposed along the circumferential direction CD. For example, one camera 27 may perform imaging a plurality of times in the circumferential direction CD while being moved along the circumferential direction CD.

In FIG. 2, the carriage 21 has a carriage main body 35, front wheels 36, rear wheels 37, a handle 38, and the like. The carriage main body 35 has a box shape. The imaging device main body 20 is attached to a top plate portion of the carriage main body 35 that is parallel to a horizontal plane.

The front wheels 36 and the rear wheels 37 are disposed on the left and right sides of a lower portion of the carriage main body 35. The carriage 21 travels on the road surface 15 by the front wheels 36 and the rear wheels 37. The rear wheels 37 are rotationally driven by a rear wheel drive unit 39. The front wheels 36 are rotated following the rotation of the rear wheels 37. That is, the carriage 21 is a four-wheel carriage and is a rear-wheel drive type.

The rear wheel drive unit 39 is two motors that are connected to the left and right rear wheels 37, respectively. The two motors rotate the left and right rear wheels 37 independently. Therefore, in a case where the right rear wheel 37 is rotated at a higher rotation speed than the left rear wheel 37 by the motor connected to the right rear wheel 37, the carriage 21 turns left. On the other hand, in a case where the left rear wheel 37 is rotated at a higher rotation speed than the right rear wheel 37 by the motor connected to the left rear wheel 37, the carriage 21 turns right.

The handle 38 is attached to an upper portion of a rear surface of the carriage main body 35. The handle 38 has a cylindrical shape that is long in a width direction of the carriage main body 35. The handle 38 is gripped by the imaging person UP to steer the carriage 21. In other words, the carriage 21 travels on the road surface 15 by the operation of the handle 38 by the imaging person UP. Here, the operation of the handle 38 by the imaging person UP is an operation of the imaging person UP gripping the handle 38 and changing a way of applying force to the handle 38 or adjusting a direction of applying force to the handle 38. As described above, the imaging person UP operates the handle 38 in the imaging device 12 to independently determine the traveling speed and direction and to drive the carriage 21.

The rear wheel drive unit 39 is also driven in response to the operation of the handle 38 by the imaging person UP. However, the rear wheel drive unit 39 is driven solely according to the force applied to the carriage 21 by the imaging person UP through the handle 38. Therefore, the carriage 21 does not travel unless the force of the imaging person UP is applied. On the contrary, the carriage 21 does not travel only by the force of the imaging person UP and travels only with the assistance of the rear wheel drive unit 39. The force applied to the carriage 21 by the imaging person UP is detected by, for example, a piezoelectric sensor (not shown), and the rear wheel drive unit 39 is driven according to the detection result. The imaging person UP may operate the imaging device 12 while riding on the carriage 21. In addition, the carriage 21 may be automatically driven without the assistance of the imaging person UP.

A plurality of magnetic bodies 40 are attached to a rear surface of the rear wheel 37 at equal angles along the circumferential direction. In addition, a magnetic sensor 41 is provided at a position that faces the magnetic body 40 in the carriage main body 35. The magnetic sensor 41 detects magnetism generated by the magnetic body 40. In a case where the rear wheels 37 are rotated, a pulse PL corresponding to the magnetism of the magnetic body 40 is output from the magnetic sensor 41 along a time axis. A moving distance of the carriage 21 and thus the imaging device 12 can be derived based on the number of pulses PL, the circumference of the rear wheel 37, the arrangement interval of the magnetic bodies 40, and the like.

A tablet terminal 42 is attached to an inclined surface that is closer to the rear wheels 37 in the carriage main body 35. The tablet terminal 42 is detachable from the carriage main body 35. The tablet terminal 42 is operated by the imaging person UP. In addition, the tablet terminal 42 may be a commercially available terminal that can be used for other purposes or may be a terminal that is not capable of being used for anything other than the imaging device 12.

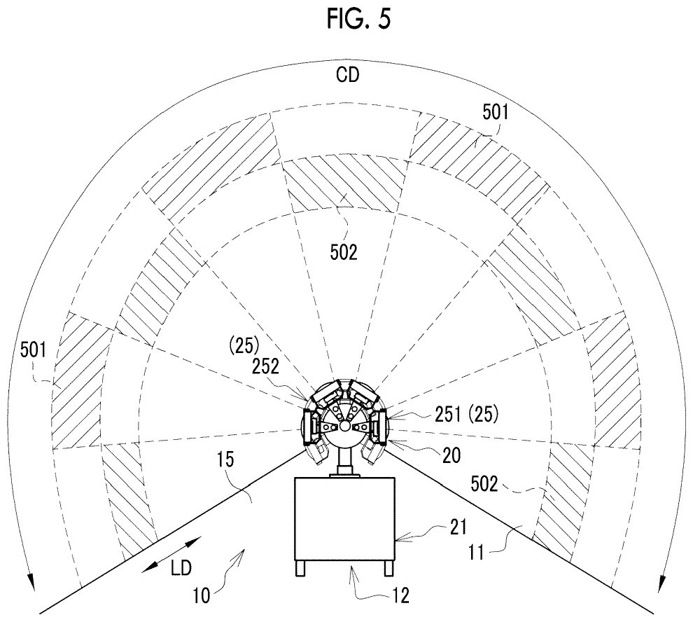

As shown in FIG. 5 as an example, the cameras 27 of the first imaging units 251 image four regions (hereinafter, referred to as first imaging regions) 501 that are spaced apart from each other among nine rectangular regions obtained by dividing the inner wall surface 11 into nine equal parts. The cameras 27 of the second imaging units 252 image five regions (hereinafter, referred to as second imaging regions) 502 that are spaced apart from each other among the nine rectangular regions obtained by dividing the inner wall surface 11 into nine equal parts.

In both the first imaging region 501 and the second imaging region 502, a short side direction is along the length direction LD, and a long side direction is along the circumferential direction CD. As shown in FIG. 4, since the arrangement phases of the first imaging units 251 and the second imaging units 252 are different in the circumferential direction CD, the first imaging regions 501 and the second imaging regions 502 are arranged in a staggered pattern. The first imaging region 501 and the second imaging region 502 are an example of “different portions of the structure” according to the technology of the present disclosure. In addition, the first imaging region 501 and the second imaging region 502 slightly overlap each other in the length direction LD and the circumferential direction CD, which is not shown in FIG. 5. Further, in FIG. 5, a direction from the back to the front of the plane of paper is the traveling direction of the carriage 21.

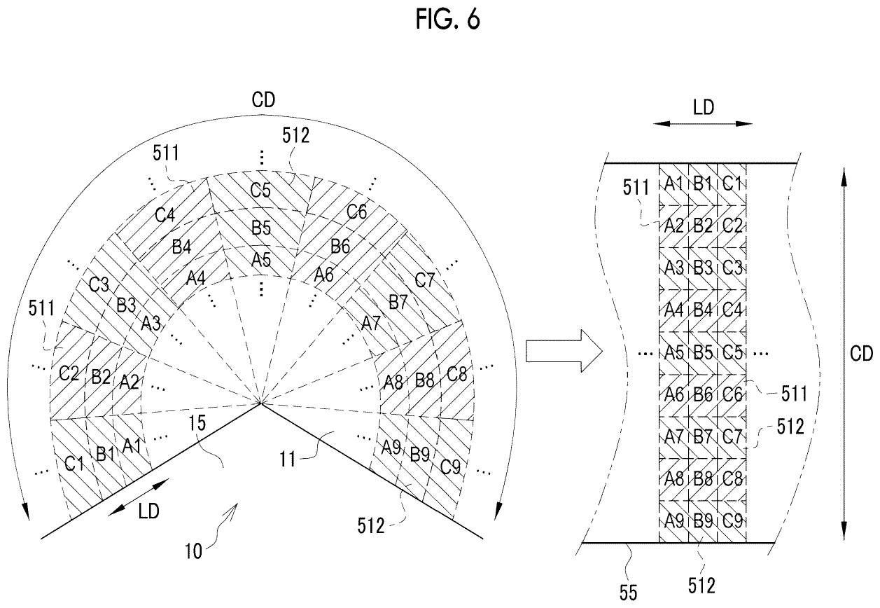

The imaging device 12 is moved along the length direction LD and images the first imaging regions 501 and the second imaging regions 502 with the cameras 27 of the first imaging units 251 and the cameras 27 of the second imaging units 252, respectively, during the movement. Therefore, as shown in FIG. 6 as an example, a plurality of first captured images 511 of the first imaging region 501 and a plurality of second captured images 512 of the second imaging region 502 are obtained.

A long image 55 covering the entire inner wall surface 11 can be generated by registering the plurality of first captured images 511 and the plurality of second captured images 512 obtained in this way based on overlapping portions and combining the plurality of first captured images 511 and the plurality of second captured images 512 along the length direction LD and the circumferential direction CD. In the long image 55, a long side direction is along the length direction LD, and a short side direction is along the circumferential direction CD. In addition, reference numerals A1 to A9 and the like indicate a correspondence relationship between the actual positions of the first captured images 511 and the second captured images 512 in the inner wall surface 11 and the positions thereof in the long image 55. Numbers 1 to 9 in the reference numerals A1 to A9 and the like are numbers attached in order to the nine regions obtained by dividing the inner wall surface 11 into nine equal parts. Even numbers 2, 4, 6, and 8 indicate the first captured images 511, and odd numbers 1, 3, 5, 7, and 9 indicate the second captured images 512. In addition, in FIG. 6, a direction from the back to the front of the plane of paper is the traveling direction of the carriage 21 as in FIG. 5. In the following description, the first captured image 511 and the second captured image 512 may be collectively referred to as a captured image 51.

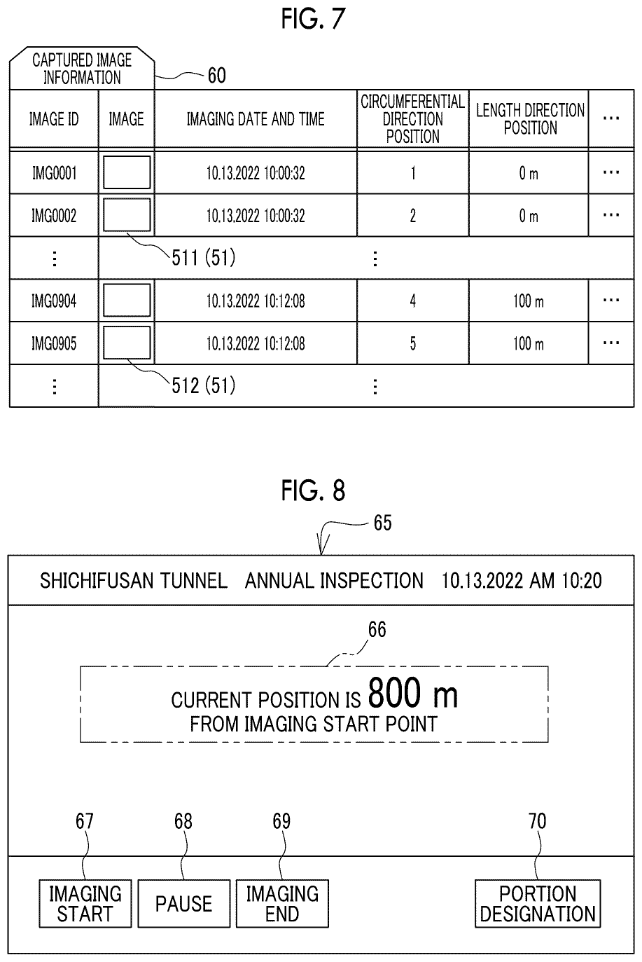

As shown in FIG. 7 as an example, the imaging device 12 generates captured image information 60 which is information of a plurality of captured images 51. The captured image information 60 is information in which the captured image 51, the capture date and time of the captured image 51, a capture position of the captured image 51 in the circumferential direction CD (referred to as a circumferential direction position in FIG. 7), a capture position of the captured image 51 in the length direction LD (referred to as a length direction position in FIG. 7), and the like are registered for each image identification data (ID) item for uniquely identifying the captured image 51. Any one of the numbers 1 to 9 in the reference numerals A1 to A9 and the like shown in FIG. 6 is registered in the capture position in the circumferential direction CD. The moving distance of the imaging device 12 derived based on the number of pulses PL and the like is registered in the capture position in the length direction LD. Further, basic information related to the captured image 51, such as the distance from the camera 27 to the object (here, the inner wall surface 11) measured by the distance measurement function, an imaging magnification, a focal length, and the number of pixels of the imaging element, is also registered in the captured image information 60.

For example, an operation screen 65 shown in FIG. 8 is displayed on a touch panel display (not shown) of the tablet terminal 42. A message 66 for notifying the imaging person UP of the distance from the entrance 13 of the tunnel 10, which is an imaging start point, to the current position is displayed on the operation screen 65. In addition, the operation screen 65 is provided with an imaging start button 67, a pause button 68, an imaging end button 69, and a portion designation button 70.

The imaging start button 67 is a button for the imaging person UP to give an instruction to start the capture of the captured image 51 to the imaging device 12. The imaging person UP selects the imaging start button 67 at, for example, the entrance 13 of the tunnel 10. In a case where the imaging start button 67 is selected, the illumination lamps 28 are turned on, and the capture of the captured image 51 by the camera 27 is started. In addition, the counting of the number of pulses PL output from the magnetic sensor 41 is also started, and the moving distance of the imaging device 12 is derived.

The pause button 68 is a button for the imaging person UP to give an instruction to pause and resume the capture of the captured image 51 to the imaging device 12. In a case where the pause button 68 is selected during imaging, the capture of the captured image 51 by the camera 27 is paused. In a case where the pause button 68 is selected again in this state, the capture of the captured image 51 by the camera 27 is resumed.

The imaging end button 69 is a button for the imaging person UP to give an instruction to end the capture of the captured image 51 to the imaging device 12. The imaging person UP selects the imaging end button 69 at, for example, the exit 14 of the tunnel 10. In a case where the imaging end button 69 is selected, the illumination lamps 28 are turned off, and the capture of the captured image 51 by the camera 27 is ended. In addition, the counting of the number of pulses PL output from the magnetic sensor 41 is also ended.

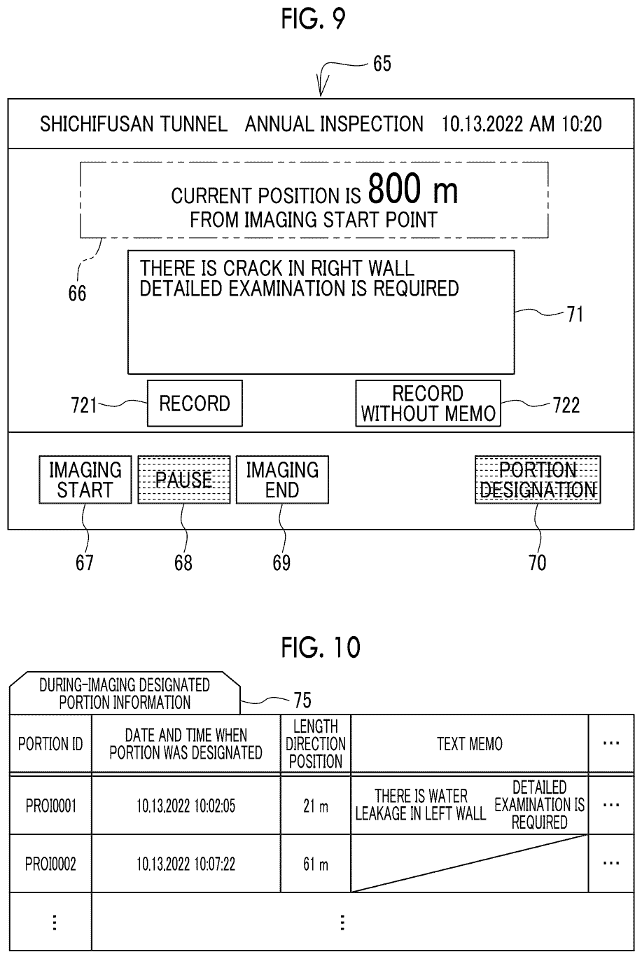

The portion designation button 70 is a button that, in a case where the imaging person UP finds a portion that the imaging person UP thinks should be examined in detail in the subsequent inspection of the long image 55 during the capture of the captured image 51 and thus the long image 55, is used by the imaging person UP to input an instruction to record the portion. In a case where the imaging person UP finds the portion that the imaging person UP thinks should be examined in detail in the inspection of the long image 55, the imaging person UP first stops the traveling of the imaging device 12. Then, the user selects the portion designation button 70 after selecting the pause button 68 to pause the capture of the captured image 51 by the camera 27. In a case where the portion designation button 70 is selected, the operation screen 65 is changed as shown in FIG. 9.

As shown in FIG. 9 as an example, an input box 71, a first recording button 721, and a second recording button 722 are provided on the operation screen 65 in a case where the portion designation button 70 is selected. A text memo related to the designated portion is input to the input box 71 by the imaging person UP. The first recording button 721 is a button for giving an instruction to record the text memo and the portion in association with each other. The second recording button 722 is a button for giving an instruction to record only the portion without recording the text memo. As described above, the portion can be recorded with a text memo or can be recorded without a text memo.

As shown in FIG. 10 as an example, the imaging device 12 generates during-imaging designated portion information 75. The during-imaging designated portion information 75 is information in which a date and time when the portion was designated, a designated position of the portion in the length direction LD (in FIG. 10, referred to as a length direction position), a text memo, and the like are registered for each portion ID for uniquely identifying the portion. Similarly to the capture position of the captured image 51 in the length direction LD, the moving distance of the imaging device 12 derived based on the number of pulses PL and the like is registered in the designated position of the portion in the length direction LD. In addition, the portion designated by the imaging person UP is an example of a “portion designated by a user” and a “portion of interest” according to the technology of the present disclosure.

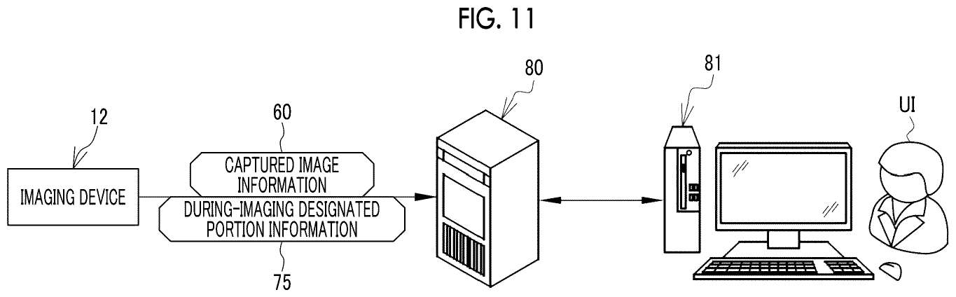

As shown in FIG. 11 as an example, the imaging device 12 is connected to an information management server 80 via a wide area network (WAN), such as the Internet or a public communication network, such that it can communicate therewith. The information management server 80 is, for example, a server computer. The information management server 80 receives the captured image information 60 and the during-imaging designated portion information 75 from the imaging device 12.

The information management server 80 is further connected to an inspector terminal 81 via a WAN, such as the Internet or a public communication network, such that it can communicate therewith. The inspector terminal 81 is a desktop personal computer, a notebook personal computer, or a tablet terminal. The inspector terminal 81 is operated by an inspector UI of the long image 55. The inspector terminal 81 is an example of an “image display device” according to the technology of the present disclosure. The inspector UI is an example of a “user” according to the technology of the present disclosure. In FIG. 11, only one inspector terminal 81 is shown. However, in practice, a plurality of inspector terminals 81 are connected to the information management server 80. Further, the inspector terminal 81 may be a commercially available terminal that can be used for other purposes or may be a terminal that is not capable of being used for anything other than the image display device.

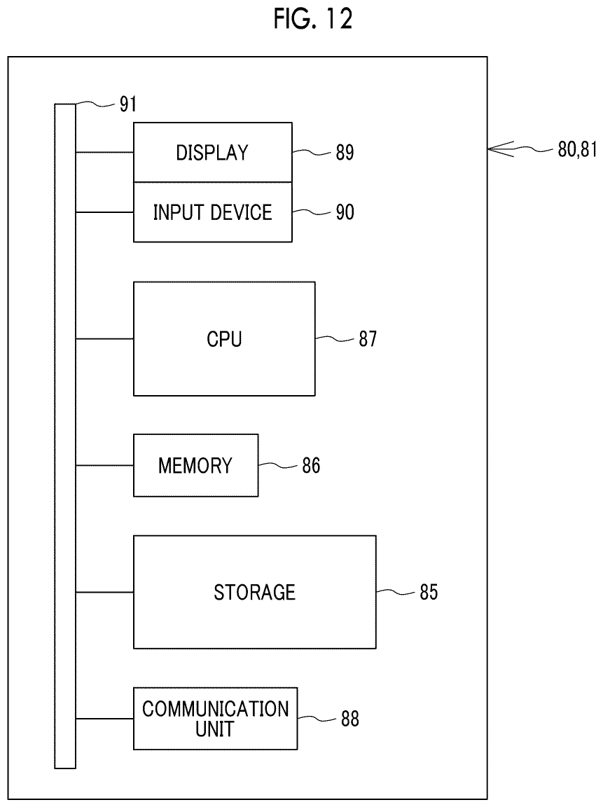

As shown in FIG. 12 as an example, computers constituting the information management server 80 and the inspector terminal 81 basically have the same configuration and comprise a storage 85, a memory 86, a central processing unit (CPU) 87, a communication unit 88, a display 89, and an input device 90. These components are connected to one another via a bus line 91.

The storage 85 is a hard disk drive that is built in the computer constituting each of the information management server 80 and the inspector terminal 81 or that is connected thereto via a cable or a network. Alternatively, the storage 85 is a disk array in which a plurality of hard disk drives are connected in series. A control program, such as an operating system, various application programs (hereinafter, abbreviated to APs), various types of data associated with these programs, and the like are stored in the storage 85. In addition, a solid state drive may be used instead of the hard disk drive.

The memory 86 is a work memory for the CPU 87 to execute processes. The CPU 87 loads the program stored in the storage 85 into the memory 86 and executes the processes corresponding to the program. Therefore, the CPU 87 controls the overall operation of each unit of the computer. In addition, the CPU 87 is an example of a “processor” according to the technology of the present disclosure. Further, the memory 86 may be built in the CPU 87.

The communication unit 88 is a network interface that executes transmission control of various types of information via a WAN or the like. The display 89 displays various screens. The various screens have operation functions by a graphical user interface (GUI). The computers constituting the information management server 80 and the inspector terminal 81 receive the input of an operation instruction from the input device 90 through the various screens. The input device 90 is, for example, a keyboard, a mouse, a touch panel, and a microphone for voice input.

Further, in the following description, the subscript “A” is attached to the reference numerals indicating each unit (the storage 85 and the CPU 87) of the computer constituting the information management server 80, and the subscript “B” is attached to the reference numerals indicating each unit (the storage 85, the CPU 87, the display 89, and the input device 90) of the computer constituting the inspector terminal 81 to distinguish the units.

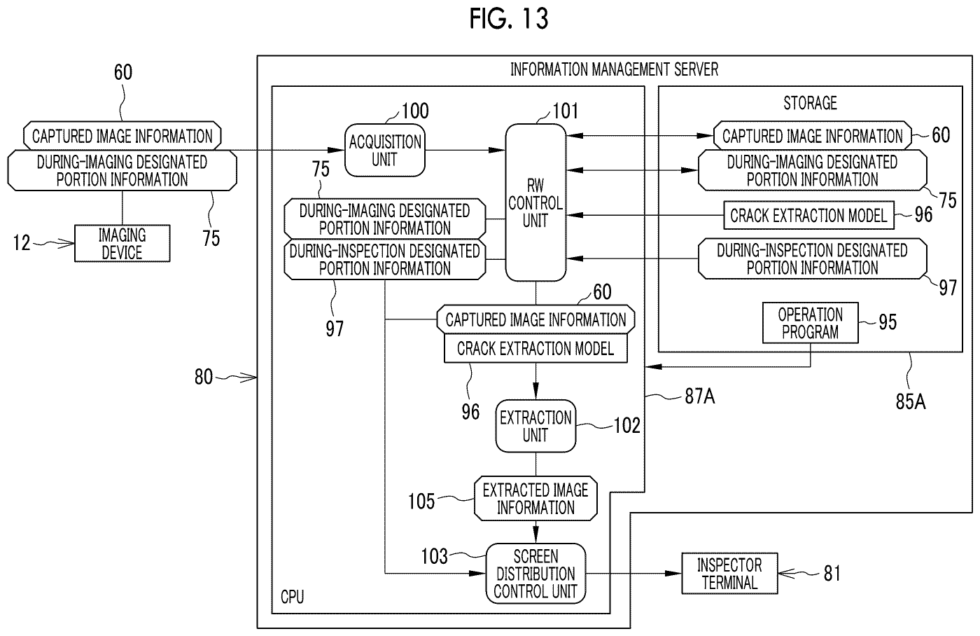

As shown in FIG. 13 as example, an operation program 95 is stored in the storage 85A of the information management server 80. The operation program 95 is an AP for causing the computer to function as the information management server 80. In addition to the operation program 95, a crack extraction model 96 and a during-inspection designated portion information 97 are stored in the storage 85A.

In a case where the operation program 95 is started, the CPU 87A of the computer constituting the information management server 80 functions as an acquisition unit 100, a read write (hereinafter, referred to as RW) control unit 101, an extraction unit 102, and a screen distribution control unit 103 in cooperation with the memory 86 and the like.

The acquisition unit 100 acquires the captured image information 60 and the during-imaging designated portion information 75 from the imaging device 12. The acquisition unit 100 outputs the captured image information 60 and the during-imaging designated portion information 75 to the RW control unit 101.

The RW control unit 101 controls the storage of various types of data in the storage 85A and the read-out of various types of data stored in the storage 85A. The RW control unit 101 stores the captured image information 60 and the during-imaging designated portion information 75 from the acquisition unit 100 in the storage 85A. The RW control unit 101 reads out the captured image information 60 from the storage 85A and outputs the read-out captured image information 60 to the extraction unit 102 and the screen distribution control unit 103. In addition, the RW control unit 101 reads out the during-imaging designated portion information 75 and the during-inspection designated portion information 97 from the storage 85A and outputs the read-out during-imaging designated portion information 75 and during-inspection designated portion information 97 to the screen distribution control unit 103. Further, the RW control unit 101 reads out the crack extraction model 96 from the storage 85A and outputs the read-out crack extraction model 96 to the extraction unit 102.

The extraction unit 102 applies the captured image 51 of the captured image information 60 to the crack extraction model 96 such that the crack extraction model 96 outputs an extracted image 110 (see FIG. 15) of cracks 111 (see FIG. 15). The extraction unit 102 outputs the extracted images 110 for all of the captured images 51. The extraction unit 102 generates extracted image information 105 which is information related to the extracted images 110 for all of the captured images 51. The extraction unit 102 outputs the extracted image information 105 to the screen distribution control unit 103.

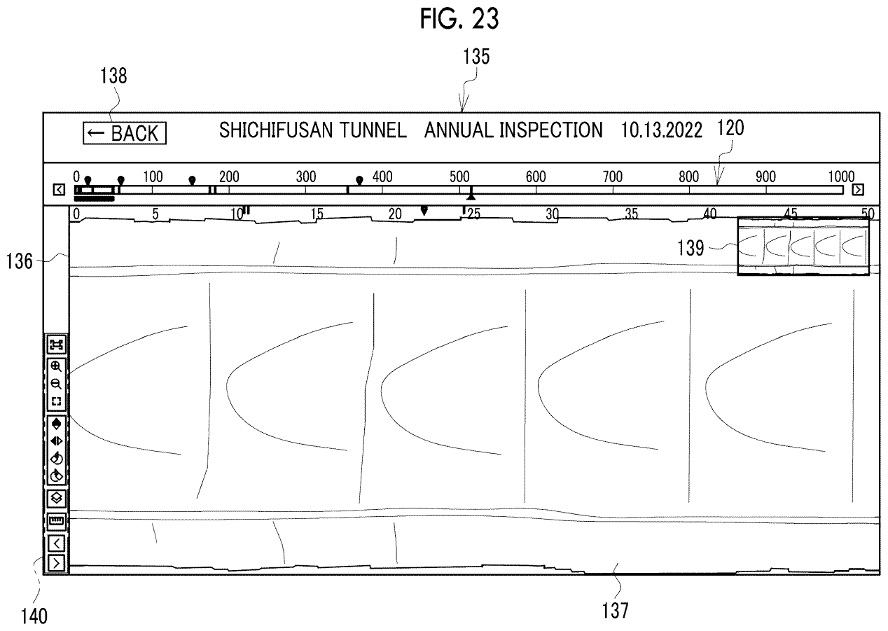

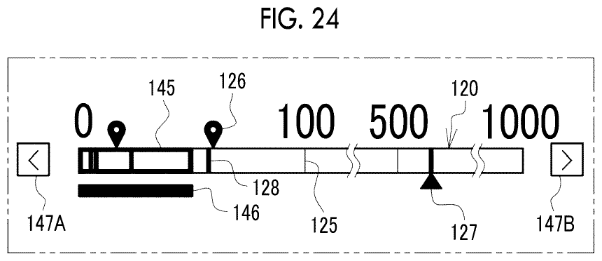

The screen distribution control unit 103 controls the generation of various screens and the distribution of the various screens to the inspector terminal 81. For example, the screen distribution control unit 103 performs control to generate a partial image display screen 135 (see FIG. 23) based on the captured image information 60, the during-imaging designated portion information 75, the during-inspection designated portion information 97, and the like and to distribute the generated partial image display screen 135 to the inspector terminal 81.

More specifically, the screen distribution control unit 103 outputs the various screens in a form of screen data for web distribution created in a markup language such as Extensible Markup Language (XML). This enables the inspector terminal 81 to browse various screens on a web browser. The screen distribution control unit 103 specifies the inspector terminal 81, which is a distribution destination of the various screens, with a terminal ID that uniquely identifies the inspector terminal and that is registered in a request to distribute various screens. Further, instead of XML, another data description language, such as JavaScript (registered trademark) Object Notation (JSON), may be used.

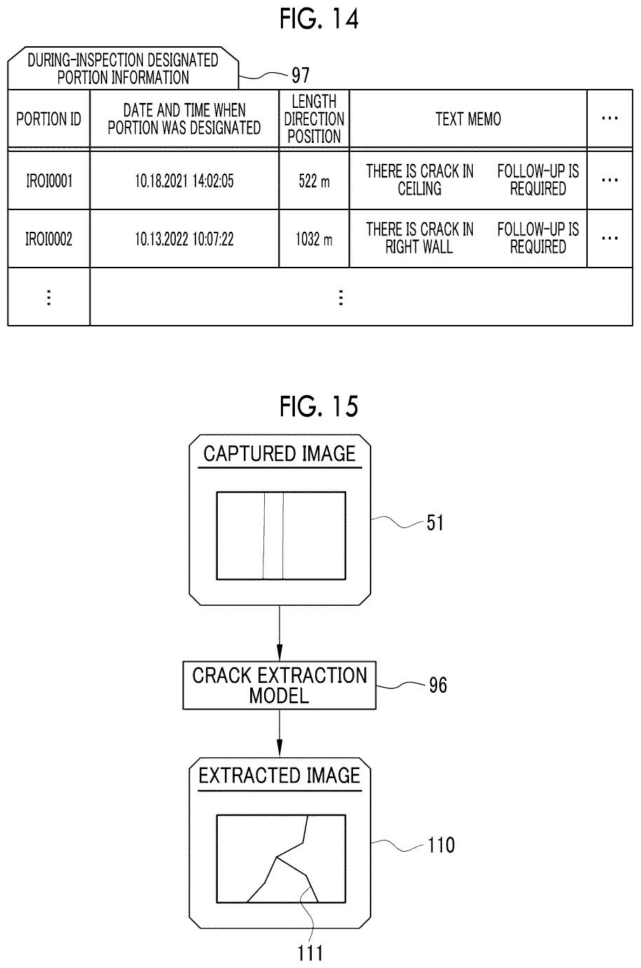

The during-inspection designated portion information 97 is information generated in a case where the inspector UI found a portion that the inspector UI thought should be monitored over time and input an instruction to record the portion on the partial image display screen 135 during the past inspection of the long image 55. As shown in FIG. 14 as an example, similarly to the during-imaging designated portion information 75, the during-inspection designated portion information 97 is information in which a date and time when the portion was designated, a designated position of the portion in the length direction LD (in FIG. 14, referred to as a length direction position), a text memo, and the like are registered for each portion ID for uniquely identifying the portion. The portion designated by the inspector UI can be recorded with a text memo or without a text memo, similarly to the portion designated by the imaging person UP. The portion designated by the inspector UI is an example of the “portion designated by the user” and the “portion of interest” according to the technology of the present disclosure, similarly to the portion designated by the imaging person UP.

As shown in FIG. 15 as an example, the extraction unit 102 inputs the captured image 51 to the crack extraction model 96 such that the crack extraction model 96 outputs the extracted image 110. The extracted image 110 is an image in which the crack 111 shown in the captured image 51 is indicated by, for example, a red line. The crack 111 is an example of a “specific object” according to the technology of the present disclosure. Further, FIG. 15 shows an example in which the crack 111 is extracted in the extracted image 110. However, there is, of course, a case where the crack 111 is not extracted in the extracted image 110.

The crack extraction model 96 is, for example, a machine learning model that is configured by a neural network. The crack extraction model 96 is repeatedly trained using, as training data, a set of the captured image 51 for learning and a correct answer image in which the crack 111 shown in the captured image 51 for learning has been manually annotated. The crack extraction model 96 outputs the extracted image 110 for learning in response to the input of the captured image 51 for learning. The crack extraction model 96 stored in the storage 85 is a model in which the extraction accuracy of the crack 111 in the extracted image 110 for training with respect to the correct answer image has reached a preset level.

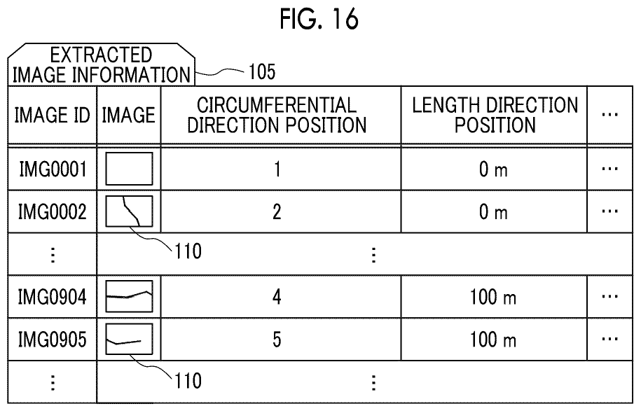

As shown in FIG. 16 as an example, the extracted image information 105 is information in which the extracted image 110, a position of the extracted image 110 in the circumferential direction CD (referred to as a circumferential direction position in FIG. 16), a position of the extracted image 110 in the length direction LD (referred to as a length direction position in FIG. 16), and the like are registered for each image identification data (ID) item for uniquely identifying the extracted image 110, similarly to the captured image information 60. The image ID of the captured image 51, the capture position of the captured image 51 in the circumferential direction CD, and the capture position of the captured image 51 in the length direction LD are transcribed in the image ID of the extracted image 110, the position of the extracted image 110 in the circumferential direction CD, and the position of the extracted image 110 in the length direction LD, respectively.

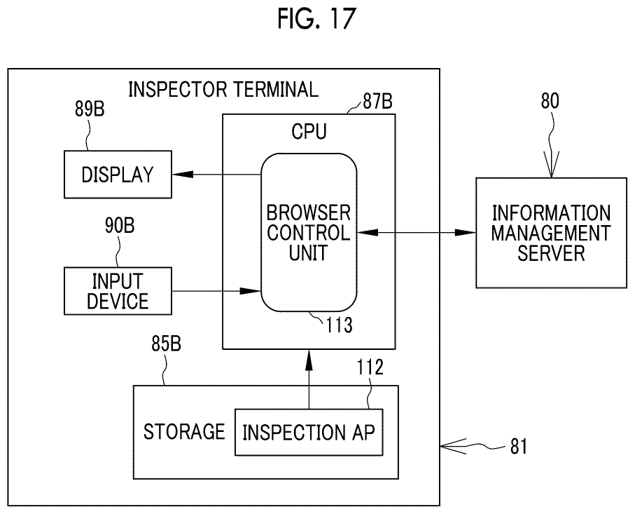

As shown in FIG. 17 as an example, an inspection AP 112 is stored in the storage 85B of the inspector terminal 81. The inspection AP 112 is installed in the inspector terminal 81 by the inspector UI. The inspection AP 112 is an AP for causing the computer constituting the inspector terminal 81 to function as an “image display device” according to the technology of the present disclosure. That is, the inspection AP 112 is an example of a “program for operating an image display device” according to the technology of the present disclosure. In a case where the inspection AP 112 is started, the CPU 87B of the inspector terminal 81 functions as a browser control unit 113 in cooperation with the memory 86 and the like. The browser control unit 113 controls the operation of a dedicated web browser of the inspection AP 112.

The browser control unit 113 generates various screens. The browser control unit 113 receives screen data of various screens from the information management server 80. The browser control unit 113 reproduces the various screens to be displayed on the web browser based on the screen data and displays the various screens on the display 89B. In addition, the browser control unit 113 receives various operation instructions input from the input device 90B by the inspector UI through various screens. The browser control unit 113 transmits various requests corresponding to the operation instructions to the information management server 80.

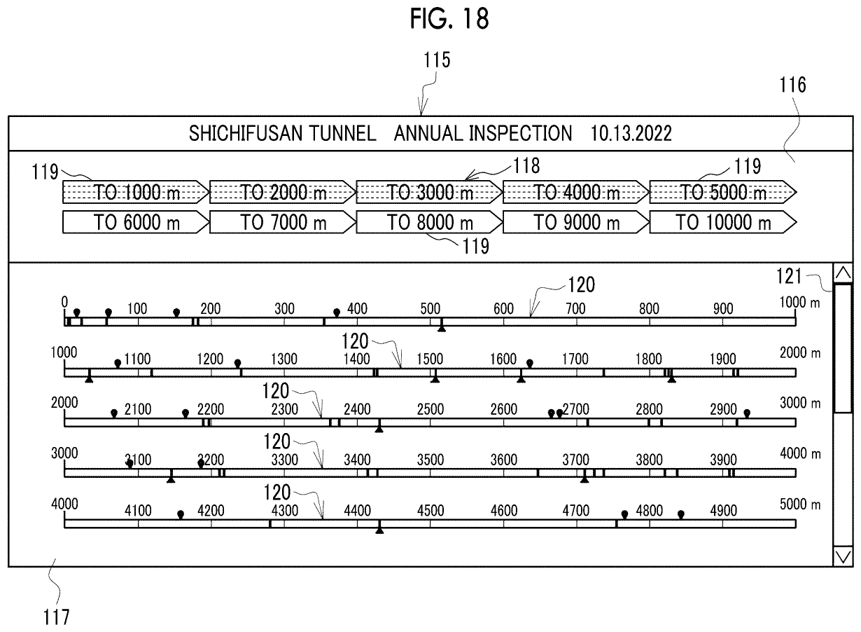

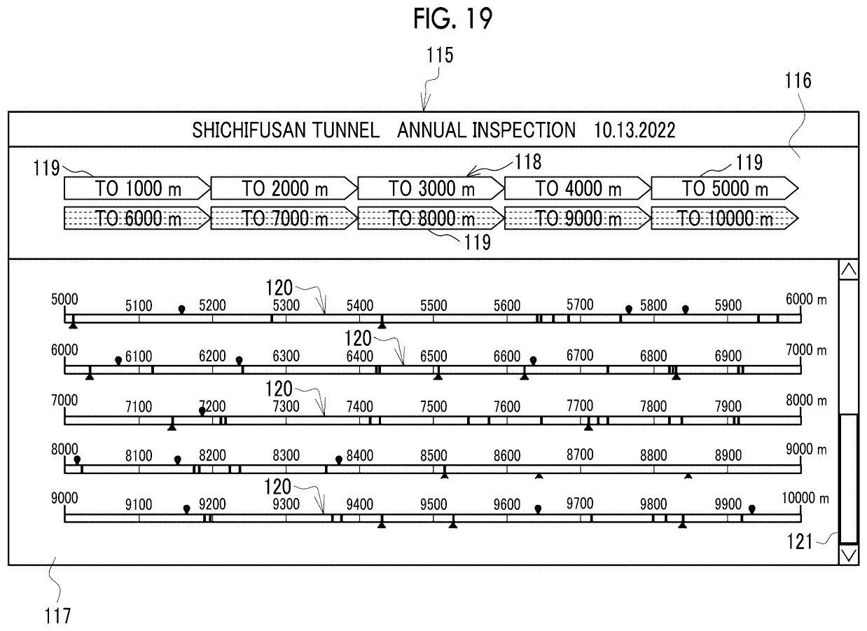

As shown in FIGS. 18 and 19 as an example, the browser control unit 113 displays a bird's-eye view screen 115 distributed from the information management server 80 on the display 89 in response to a request from the inspector UI. The bird's-eye view screen 115 is divided into two regions of an upper display region 116 and a lower display region 117. A whole index bar 118 is displayed in the upper display region 116. The whole index bar 118 is an elongated rod-like GUI in which a long side direction is matched with the length direction LD. The whole index bar 118 indicates a distance range of 0 m to 10000 m. That is, the distance range of 0 m to 10000 m is the distance range of the total length of the tunnel 10. The whole index bar 118 is an example of a “second index bar” according to the technology of the present disclosure. In addition, the distance range of 0 m to 10000 m is an example of a “second distance range” according to the technology of the present disclosure.

The whole index bar 118 is divided into small regions 119 each of which is 1000 m. Five small regions 119 of 0 m to 5000 m in the first half of the tunnel 10 are disposed in an upper portion of the upper display region 116, and five small regions 119 of 5000 m to 10000 m in the second half of the tunnel 10 are disposed in a lower portion of the upper display region 116.

A partial index bar 120 is displayed in the lower display region 117. The partial index bar 120 is an elongated rod-like GUI in which the long side direction is matched with the length direction LD, similarly to the whole index bar 118. The partial index bars 120 indicate 10 distance ranges of 0 m to 1000 m, 1000 m to 2000 m, 2000 m to 3000 m, . . . , 7000 m to 8000 m, 8000 m to 9000 m, and 9000 m to 10000 m obtained by dividing 0 m to 10000 m, which is the distance range of the total length of the tunnel 10, into 10 equal parts. The partial index bar 120 is an example of a “first index bar” according to the technology of the present disclosure. In addition, the distance range of 0 m to 1000 m, 1000 m to 2000 m, or the like is an example of a “first distance range” according to the technology of the present disclosure.

A maximum of only five partial index bars 120 corresponding to 5000 m can be displayed in the lower display region 117. A scroll bar 121 is provided in the lower display region 117. The scroll bar 121 can be operated to change the partial index bars 120 displayed in the lower display region 117. In addition, the partial index bars 120 to be displayed in the lower display region 117 can also be changed by placing a cursor 130 of a mouse (see FIG. 21 and the like) on a desired small region 119 of the whole index bar 118 and single-clicking the mouse. For example, in a case where the small region 119 corresponding to the distance range of 2000 m to 3000 m is selected, the partial index bars 120 from the partial index bar 120 indicating the distance range of 2000 m to 3000 m to the partial index bar 120 indicating the distance range of 6000 m to 7000 m are displayed in the lower display region 117.

On the bird's-eye view screen 115, at least one of the brightness, color, or pattern of the small region 119, which corresponds to the distance range indicated by the partial index bar 120 being displayed in the lower display region 117, among the small regions 119 of the whole index bar 118 is changed (indicated by hatching) such that the small region 119 is displayed to be distinguishable from the other small regions 119. This display makes it possible to indicate which position in the distance range of 0 m to 10000 m the partial index bar 120 being displayed in the lower display region 117 corresponds to. In addition, FIG. 18 shows a case where the partial index bars 120 corresponding to 0 m to 1000 m, 1000 m to 2000 m, 2000 m to 3000 m, 3000 m to 4000 m, and 4000 m to 5000 m are being displayed in the lower display region 117. In addition, FIG. 19 shows a case where partial index bars 120 corresponding to 5000 m to 6000 m, 6000 m to 7000 m, 7000 m to 8000 m, 8000 m to 9000 m, and 9000 m to 10000 m are being displayed in the lower display region 117.

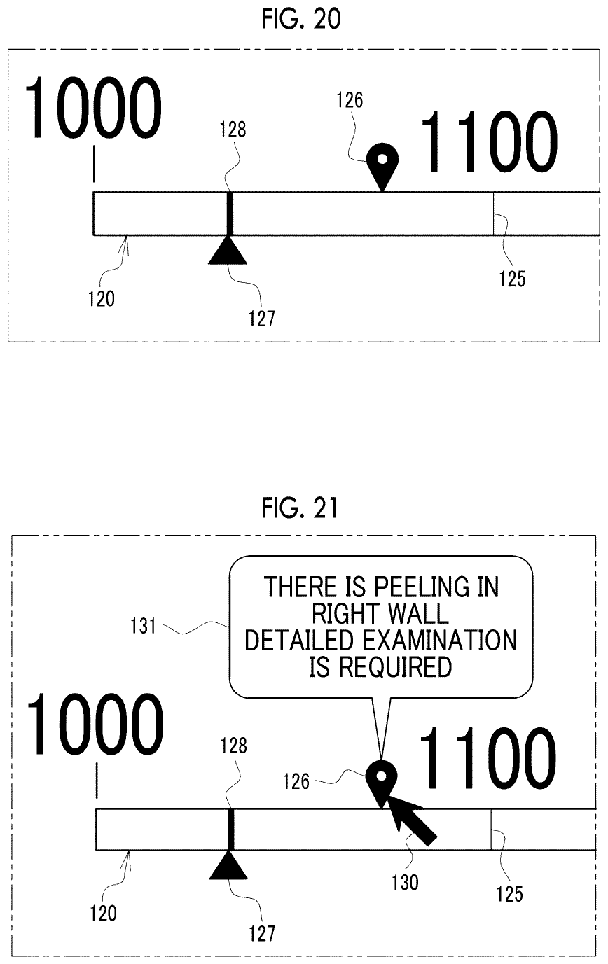

As shown in FIG. 20 as an example, numerical values and gradations 125 indicating distances are displayed for every 100 m on the partial index bar 120. In addition, a during-imaging designated portion mark 126 is displayed in an upper portion of the partial index bar 120, a during-inspection designated portion mark 127 is displayed in a lower portion thereof, and a crack presence portion mark 128 is displayed therein. The during-imaging designated portion mark 126, the during-inspection designated portion mark 127, and the crack presence portion mark 128 are examples of a “portion-of-interest mark” according to the technology of the present disclosure.

The during-imaging designated portion mark 126 is a mark that imitates a pin shape. The screen distribution control unit 103 disposes the during-imaging designated portion mark 126 at the position of the partial index bar 120 corresponding to the designated position of the portion in the length direction LD in the during-imaging designated portion information 75.

The during-inspection designated portion mark 127 is a triangular mark that imitates an arrowhead shape. The screen distribution control unit 103 disposes the during-inspection designated portion mark 127 at the position of the partial index bar 120 corresponding to the designated position of the portion in the length direction LD in the during-inspection designated portion information 97.

The crack presence portion mark 128 is a line that extends over the entire width direction of the partial index bar 120. The crack presence portion mark 128 is thicker than the gradation 125 to be distinguished from the gradation 125. The screen distribution control unit 103 disposes the crack presence portion mark 128 at the position of the partial index bar 120 corresponding to the position of the extracted image 110, in which the crack 111 having a length equal to or greater than a threshold value has been extracted, in the length direction LD. In addition, the portion in which the crack 111 having the length equal to or greater than the threshold value is present is an example of the “portion of interest” according to the technology of the present disclosure, similarly to the portion designated by the imaging person UP and the portion designated by the inspector UI.

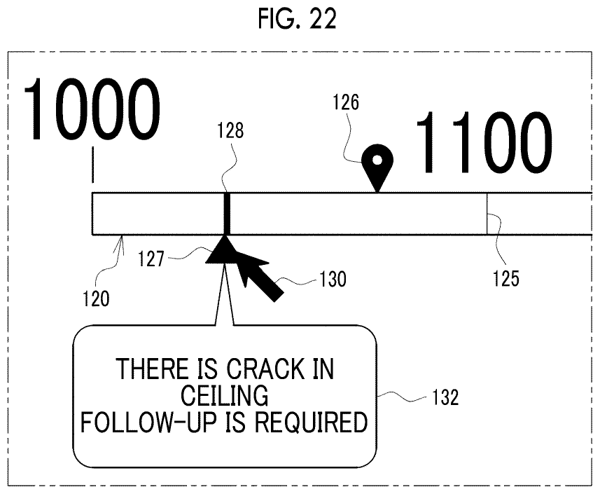

The during-imaging designated portion mark 126 and the during-inspection designated portion mark 127 can be selected by the cursor 130 of the mouse. In a case where the during-imaging designated portion mark 126 is selected, as shown in FIG. 21 as an example, a balloon 131 of a text memo recorded in association with the portion designated by the imaging person UP is displayed above the selected during-imaging designated portion mark 126. In addition, in a case where the during-inspection designated portion mark 127 is selected, as shown in FIG. 22 as an example, a balloon 132 of a text memo recorded in association with the portion designated by the inspector UI is displayed below the selected during-inspection designated portion mark 127. In a case where no text memo is recorded, the balloons 131 and 132 are not displayed.

In a case where an instruction to place the cursor 130 of the mouse on a desired small region 119 of the whole index bar 118 and to double-click the mouse is input on the bird's-eye view screen 115, the browser control unit 113 transmits a request to distribute the partial image display screen 135 to the information management server 80. The screen distribution control unit 103 receives the request to distribute the partial image display screen 135, generates the partial image display screen 135 shown in FIG. 23 as an example, and distributes the generated partial image display screen 135 to the inspector terminal 81. The browser control unit 113 displays the partial image display screen 135 on the display 89B.

The partial image display screen 135 has the partial index bar 120 and a partial image display region 136. A partial image 137, which is a portion of the long image 55, is displayed in the partial image display region 136. Here, the partial image 137 is an image in a distance range of 50 m. In an initial display state of the partial image display screen 135, the partial image 137 in the distance range of 50 m from the end closer to the entrance 13 is displayed.

Numerical values indicating the distances are displayed every 5 m in an upper portion of the partial image display region 136. In addition, the during-imaging designated portion mark 126, the during-inspection designated portion mark 127, and the crack presence portion mark 128 are displayed in the upper portion of the partial image display region 136, similarly to the partial index bar 120.

FIG. 23 shows an example in which the small region 119 of 0 m to 1000 m is double-clicked on the bird's-eye view screen 115 and the partial index bar 120 of 0 m to 1000 m and the partial image 137 in the distance range of 0 m to 50 m are displayed. In addition, the partial image display screen 135 is an example of a “display screen” according to the technology of the present disclosure. Further, the partial image display region 136 is an example of a “display region” according to the technology of the present disclosure.

A back button 138 is provided in an upper portion of the partial image display screen 135. In a case where the back button 138 is selected, the display is returned to the bird's-eye view screen 115. In addition, an auxiliary window 139 in which the partial image 137 in the initial display state before enlargement display is displayed is provided in the partial image display region 136. Further, an operation button group 140 is provided on the left side of the partial image display region 136.

The partial index bar 120 of the partial image display screen 135 has basically the same display form as the partial index bar 120 of the bird's-eye view screen 115. For example, the numerical values and gradations 125 indicating distances are displayed every 100 m, and the during-imaging designated portion mark 126 is displayed on the partial index bar 120 of the partial image display screen 135. However, as shown in FIG. 24 as an example, a capture position mark 145 is displayed on the partial index bar 120 of the partial image display screen 135. The capture position mark 145 indicates the capture position of the partial image 137 being displayed in the partial image display region 136 in the tunnel 10. The capture position mark 145 is specifically a frame that surrounds the distance range of the tunnel 10 shown in the partial image 137. FIG. 24 shows an example in which the partial image 137 in the distance range of 0 m to 50 m is displayed in the partial image display region 136 and the capture position mark 145 surrounding the distance range of 0 m to 50 m is displayed on the partial index bar 120.

A display completion mark 146 indicating the portion whose partial image 137 is displayed is displayed below the partial index bar 120. The display completion mark 146 is a filled bar that extends along the long side direction of the partial index bar 120. The display completion mark 146 makes it possible to display the portion whose partial image 137 is displayed and the portion whose partial image 137 is not displayed to be distinguished from each other. In addition, as in the case of the bird's-eye view screen 115, the text memo balloons 131 and 132 are displayed on the partial image display screen 135 in response to the selection of the during-imaging designated portion mark 126 and the during-inspection designated portion mark 127, which is not shown.

Distance range switching buttons 147A and 147B are provided on the left and right sides of the partial index bar 120. In a case where the distance range switching button 147A is selected, the display of the partial index bar 120 is switched to the previous partial index bar 120 on the side of the entrance 13. On the other hand, in a case where the distance range switching button 147B is selected, the display of the partial index bar 120 is switched to the next partial index bar 120 on the side of the exit 14. In addition, the display of the partial image 137 in the partial image display region 136 is switched in operative association with the change in the display of the partial index bar 120.

For example, a case is considered in which the partial index bar 120 of the distance range of 3000 m to 4000 m is displayed and the distance range switching button 147A is selected. In this case, the display of the partial index bar 120 of the distance range of 3000 m to 4000 m is switched to the partial index bar 120 of the distance range of 2000 m to 3000 m. In addition, the display of the partial image 137 in the partial image display region 136 is switched to the partial image 137 in the distance range of 2000 m to 2050 m. In addition, for example, a case is considered in which the partial index bar 120 of the distance range of 7000 m to 8000 m is displayed and the distance range switching button 147B is selected. In this case, the display of the partial index bar 120 of the distance range of 7000 m to 8000 m is switched to the partial index bar 120 of the distance range of 8000 m to 9000 m. In addition, the display of the partial image 137 in the partial image display region 136 is switched to the partial image 137 in the distance range of 8000 m to 8050 m.

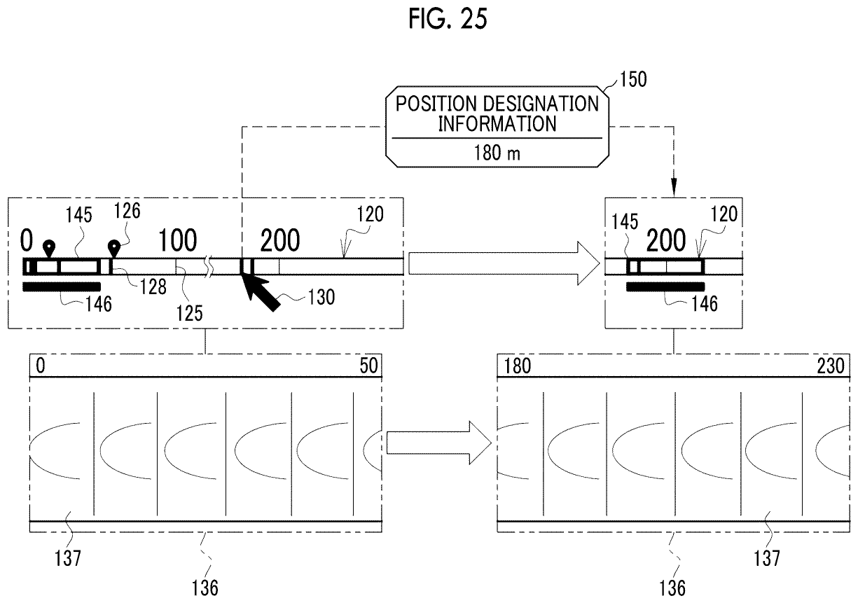

As shown in FIG. 25 as an example, it is possible to designate any position of the partial index bar 120 with the cursor 130 on the partial image display screen 135. In a case where the designation of the position is received, the browser control unit 113 generates position designation information 150 indicating the designated position and transmits the position designation information 150 to the information management server 80. The screen distribution control unit 103 displays the partial image 137 whose capture position corresponds to the designated position in the partial image display region 136. In addition, the screen distribution control unit 103 also changes the display of the capture position mark 145 in response to the change in the display of the partial image 137. Further, in a case where the partial image 137 whose display has been changed is a partial image 137 that has not been displayed so far, the screen distribution control unit 103 displays the display completion mark 146 below the partial index bar 120. The screen distribution control unit 103 distributes the partial image display screen 135 generated in this way to the inspector terminal 81.

FIG. 25 shows a case where a position of 180 m in the partial index bar 120 is designated by the cursor 130. In this case, the partial image 137 in the partial image display region 136 is switched from the partial image 137 in the distance range of 0 m to 50 m to the partial image 137 in the distance range of 180 m to 230 m. In addition, the capture position mark 145 is also switched from the distance range of 0 m to 50 m to the distance range of 180 m to 230 m, and the display completion mark 146 is displayed below the distance range of 180 m to 230 m.

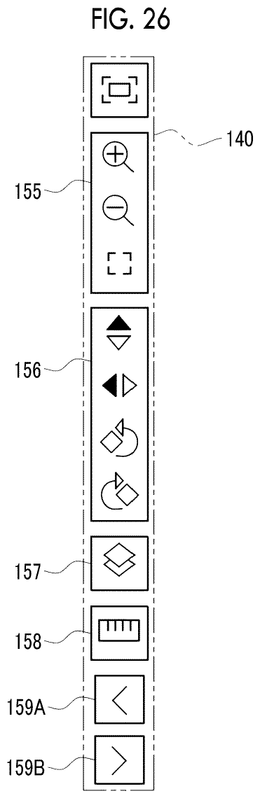

As shown in FIG. 26 as an example, the operation button group 140 includes a zoom button 155, a movement and rotation button 156, a superimposition/superimposition cancellation button 157, a measurement button 158, display switching buttons 159A and 159B, and the like.

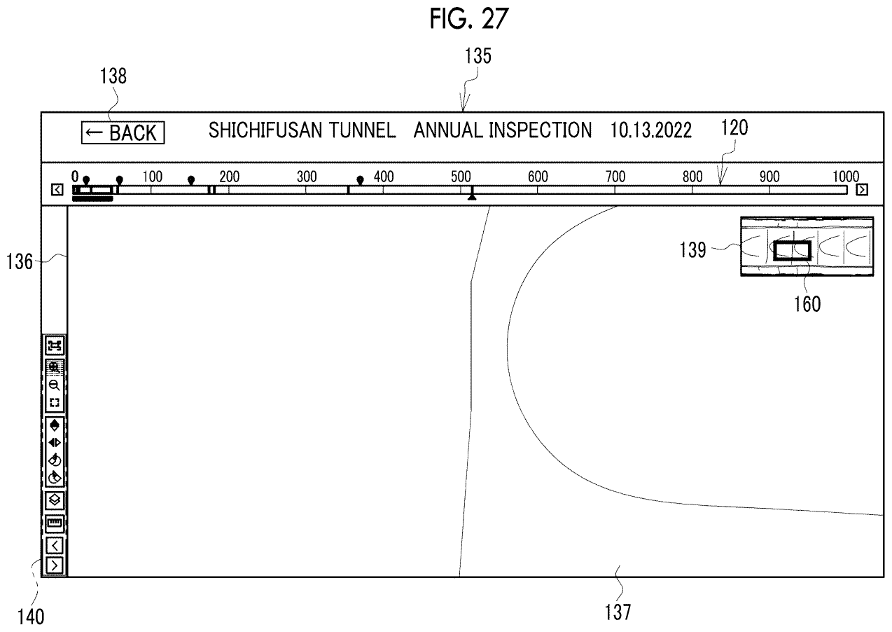

The zoom button 155 is a button for enlarging or reducing the display size of the partial image 137 in the partial image display region 136. As shown in FIG. 27 as an example, in a case where the zoom button 155 is operated to enlarge the display size of the partial image 137 in the partial image display region 136, a frame 160 is displayed in the auxiliary window 139. The frame 160 indicates which position of the partial image 137 in the initial display state before enlargement display the portion, which is currently displayed to be enlarged, corresponds to.

The movement and rotation button 156 is a button for changing the display position of the partial image 137 in the partial image display region 136 to any of the up, down, left, or right side. In addition, the movement and rotation button 156 is a button for changing the display orientation of the partial image 137 in the partial image display region 136 clockwise or counterclockwise by a predetermined angle (for example, 90°).

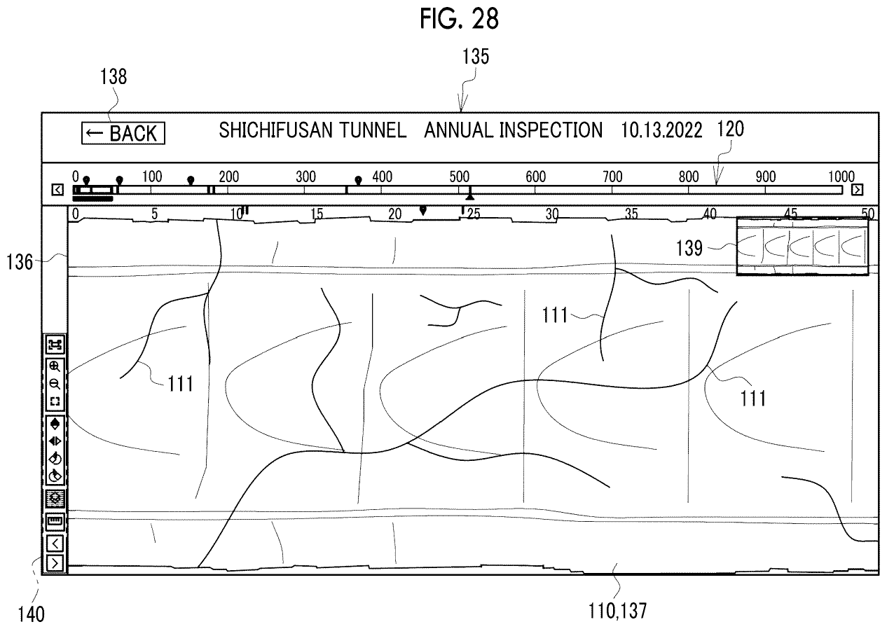

The superimposition/superimposition cancellation button 157 is a button for giving an instruction to superimpose the extracted image 110 on the partial image 137 in the partial image display region 136 and to cancel the superimposition. In a case where the superimposition/superimposition cancellation button 157 is selected in FIG. 23, as shown in FIG. 28 as an example, the extracted image 110 is displayed to be superimposed on the partial image 137 in the partial image display region 136. In a case where the superimposition/superimposition cancellation button 157 is selected again in this state, the superimposition of the extracted image 110 is cancelled, and the display returns to the display form shown in FIG. 23.

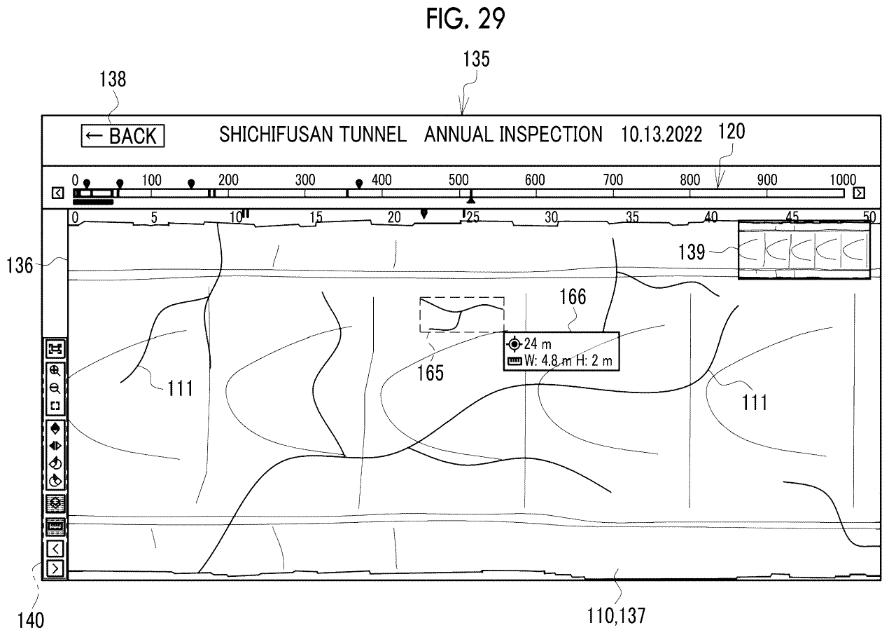

The measurement button 158 is a button for displaying the position of an object to be measured in the tunnel 10 in the partial image 137 in the partial image display region 136 and the actual size of the object be measured. As shown in FIG. 29 as an example, in a case where the measurement button 158 is selected and a rectangular region 165 surrounding the crack 111 as the object to be measured is designated, a display window 166 including the position of the crack 111 designated by the region 165 in the tunnel 10 and the actual size of the crack 111 designated by the region 165 is displayed in the partial image display region 136. The position of the crack 111 designated by the region 165 in the tunnel 10 is the position of a center of a side along the length direction LD of the region 165. In addition, here, the actual size is a width W of the crack 111 designated by the region 165 in the length direction LD and a height H thereof in the circumferential direction CD. FIG. 29 shows a case where the position in the tunnel 10 is 24 m, the width W is 4.8 m, and the height H is 2 m.

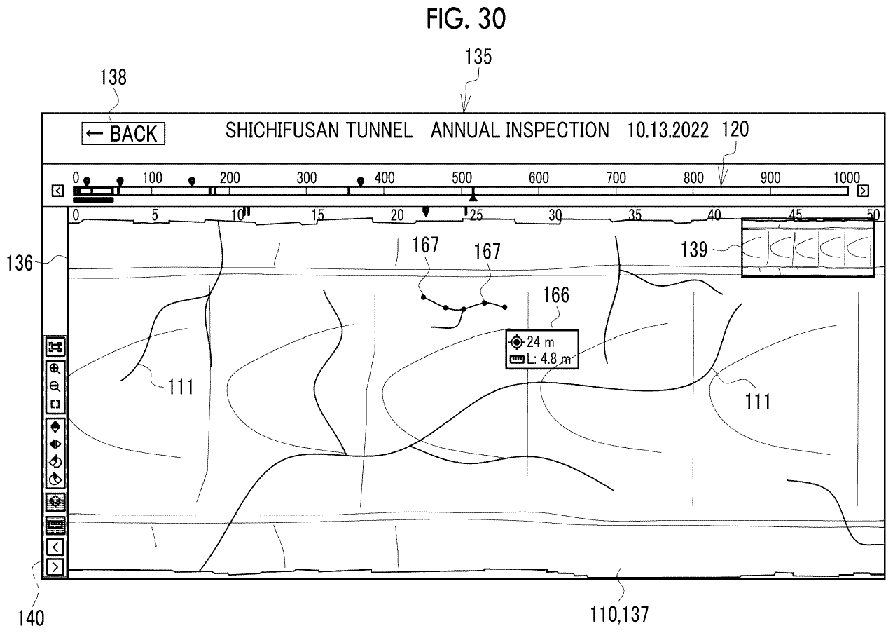

In addition, as shown in FIG. 30 as an example, in a case where the measurement button 158 is selected and a plurality of points 167 on the crack 111 as the object to be measured are designated, the display window 166 including the position of the crack 111 designated by the points 167 in the tunnel 10 and the actual size of the crack 111 designated by the points 167 is displayed in the partial image display region 136. The position of the crack 111 designated by the points 167 in the tunnel 10 is a position of a center of a line connecting the points 167. In addition, the actual size is a length L of the line connecting the points 167. FIG. 30 shows a case where the position in the tunnel 10 is 24 m and the length L is 4.8 m. As described above, the object to be measured may be designated by the rectangular region 165 shown in FIG. 29 or the points 167 shown in FIG. 30. In addition, the actual size can be calculated from the distance to the object measured by the distance measurement function of the camera 27, the imaging magnification, the focal length, the number of pixels of the imaging element, the pixel size, the pixel pitch, and the like.

The display switching buttons 159A and 159B are buttons for switching the display of the partial image 137 being displayed in the partial image display region 136. The display switching buttons 159A and 159B are examples of an “operation portion” according to the technology of the present disclosure.

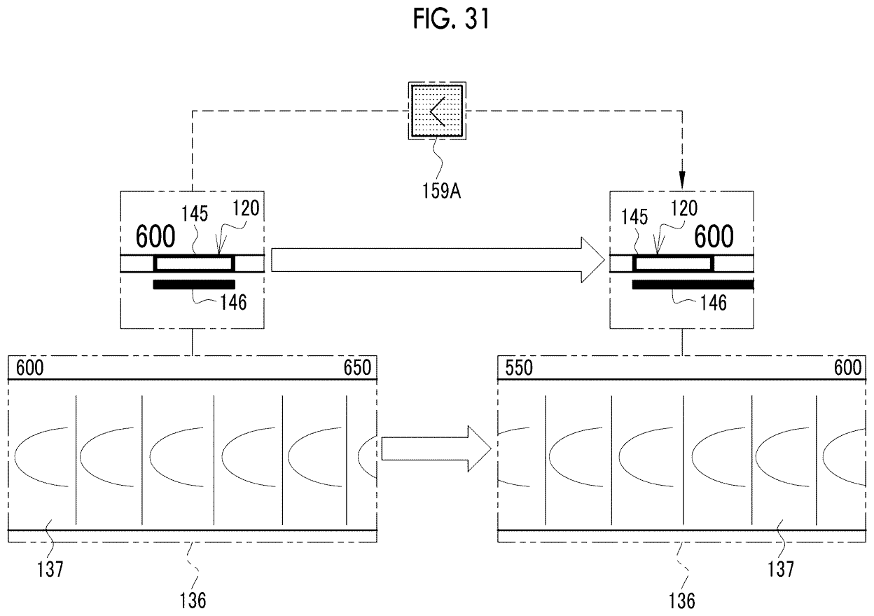

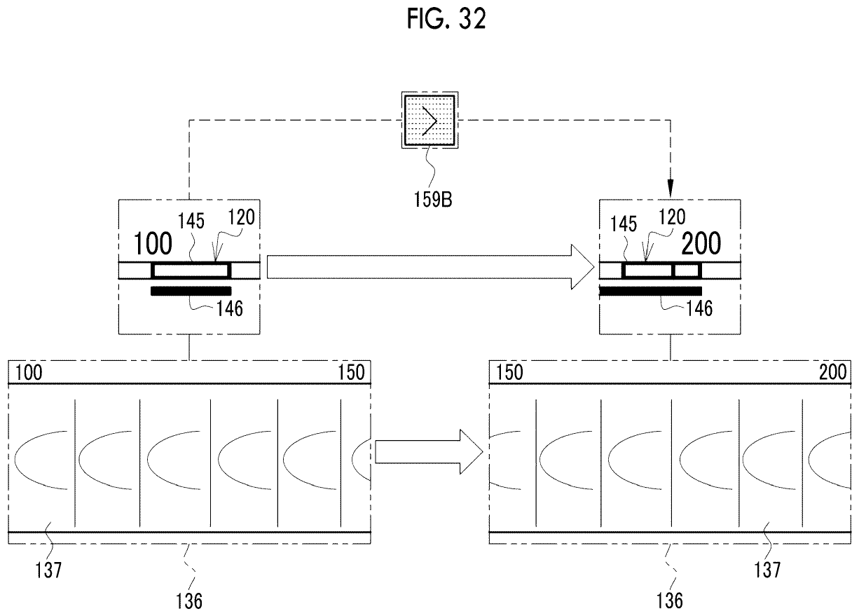

As shown in FIGS. 31 and 32 as an example, in a case where the display switching buttons 159A and 159B are selected, the partial image 137 being displayed in the partial image display region 136 is switched to a partial image 137 adjacent to the partial image 137 being displayed in the partial image display region 136.

FIG. 31 shows a case where the partial image 137 in a distance range of 600 m to 650 m is displayed in the partial image display region 136 and the display switching button 159A is selected. In this case, the display of the partial image 137 in the partial image display region 136 is switched to a partial image 137 in a distance range of 550 m to 600 m adjacent to the partial image 137 in the distance range of 600 m to 650 m. In addition, the display of the capture position mark 145 is also switched from the distance range of 600 m to 650 m to the distance range of 550 m to 600 m. Further, the display completion mark 146 is also displayed below the distance range of 550 m to 600 m. In this case, the partial image 137 in the distance range of 550 m to 600 m is an example of an “adjacent partial image” according to the technology of the present disclosure. Furthermore, in a case where the partial image 137 in the distance range of 550 m to 600 m has been displayed until that time, the display completion mark 146 has already been displayed below the distance range of 550 m to 600 m.

FIG. 32 shows a case where the partial image 137 in a distance range of 100 m to 150 m is displayed in the partial image display region 136 and the display switching button 159B is selected. In this case, the display of the partial image 137 in the partial image display region 136 is switched to a partial image 137 in a distance range of 150 m to 200 m adjacent to the partial image 137 in the distance range of 100 m to 150 m. In addition, the display of the capture position mark 145 is also switched from the distance range of 100 m to 150 m to the distance range of 150 m to 200 m. Further, the display completion mark 146 is also displayed below the distance range of 150 m to 200 m. In this case, the partial image 137 in the distance range of 150 m to 200 m is an example of the “adjacent partial image” according to the technology of the present disclosure. In a case where the partial image 137 in the distance range of 150 m to 200 m has been displayed until that time, the display completion mark 146 has already been displayed below the distance range of 150 m to 200 m.

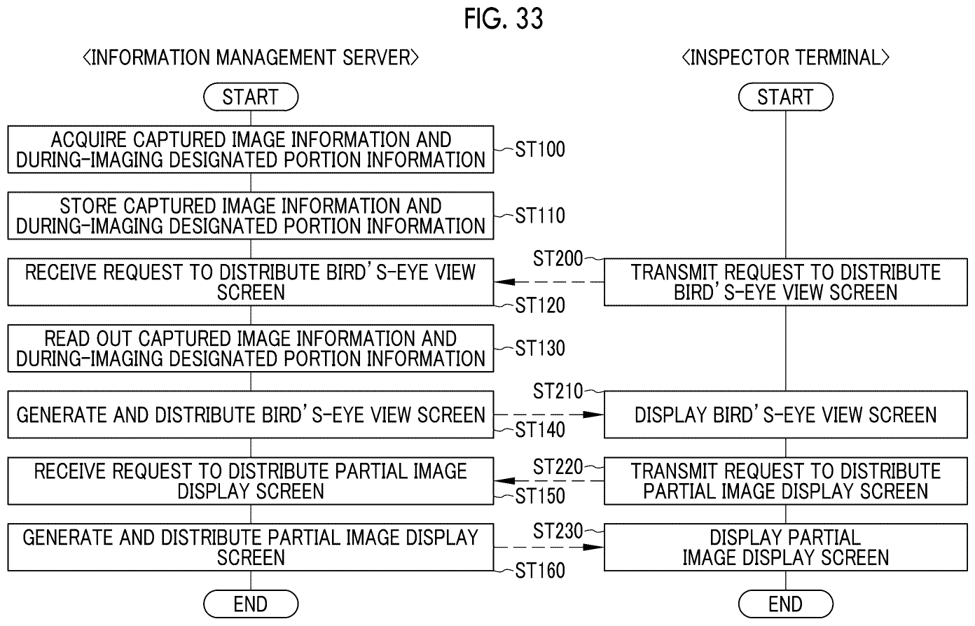

Next, the operation of the above-described configuration will be described with reference to a flowchart shown in FIG. 33 as an example. As shown in FIGS. 1, 5, and 6, the inner wall surface 11 of the tunnel 10 is imaged by the cameras 27 of the imaging device 12. In this case, the moving distance of the imaging device 12 is derived based on the pulses PL output from the magnetic sensors 41 according to the magnetism of the magnetic bodies 40 attached to the rear wheels 37 of the carriage 21 of the imaging device 12. Then, as shown in FIG. 7, the imaging device 12 generates the captured image information 60 which is information of the captured image 51 obtained by the imaging. In addition, as shown in FIG. 10, the during-imaging designated portion information 75, which is information of the portion designated by the imaging person UP through the operation screen 65 shown in FIG. 8 and the like, is generated.

In a case where the operation program 95 is started in the information management server 80, as shown in FIG. 13, the CPU 87A of the information management server 80 functions as the acquisition unit 100, the RW control unit 101, the extraction unit 102, and the screen distribution control unit 103. In addition, in a case where the inspection AP 112 is started in the inspector terminal 81, as shown in FIG. 17, the CPU 87B of the inspector terminal 81 functions as the browser control unit 113.

As shown in FIG. 11, the captured image information 60 and the during-imaging designated portion information 75 are transmitted from the imaging device 12 to the information management server 80. The captured image information 60 and the during-imaging designated portion information 75 are acquired by the acquisition unit 100 (Step ST100). The captured image information 60 and the during-imaging designated portion information 75 are output from the acquisition unit 100 to the RW control unit 101 and are stored in the storage 85A by the RW control unit 101 (Step ST110).

The inspector UI inputs a request to distribute the bird's-eye view screen 115 to the inspector terminal 81, and the distribution request is transmitted from the browser control unit 113 to the information management server 80 (Step ST200). In a case where the request to distribute the bird's-eye view screen 115 is received (Step ST120), the RW control unit 101 reads out the captured image information 60 and the during-imaging designated portion information 75 from the storage 85A (Step ST130). The captured image information 60 and the during-imaging designated portion information 75 are output from the RW control unit 101 to the screen distribution control unit 103. In addition, the captured image information 60 is output to the extraction unit 102 together with the crack extraction model 96. Further, the during-inspection designated portion information 97 is also read out from the storage 85A by the RW control unit 101 and is output from the RW control unit 101 to the screen distribution control unit 103 together with the captured image information 60 and the like.

The bird's-eye view screen 115 shown in FIGS. 18 and 19 is generated by the screen distribution control unit 103 and is distributed to the inspector terminal 81 (Step ST140). In the inspector terminal 81, the browser control unit 113 displays the bird's-eye view screen 115 on the display 89B (Step ST210). The whole index bar 118 is displayed in the upper display region 116 of the bird's-eye view screen 115, and the partial index bar 120 is displayed in the lower display region 117.

The whole index bar 118 is divided into a plurality of small regions 119 each of which is 1000 m. A small region 119 corresponding to the distance range indicated by the partial index bar 120 being displayed in the lower display region 117 among the plurality of small regions 119 is displayed to be distinguished from the other small regions 119. In addition, as shown in FIG. 20, the during-imaging designated portion mark 126, the during-inspection designated portion mark 127, and the crack presence portion mark 128 are displayed on the partial index bar 120.

An instruction to distribute the partial image display screen 135 is input on the bird's-eye view screen 115, and a distribution request corresponding to the distribution instruction is transmitted from the browser control unit 113 to the information management server 80 (Step ST220). In a case where the request to distribute the partial image display screen 135 is received (Step ST150), the partial image display screen 135 shown in FIG. 23 and the like is generated by the screen distribution control unit 103 and is distributed to the inspector terminal 81 (Step ST160). In the inspector terminal 81, the browser control unit 113 displays the partial image display screen 135 on the display 89B (Step ST230).

The partial image display screen 135 has the partial index bar 120 and the partial image display region 136. However, the partial image display screen 135 does not have a display region for the long image 55. The partial image 137, which is a portion of the long image 55, is displayed in the partial image display region 136. The capture position mark 145 indicating the capture position of the partial image 137 being displayed in the partial image display region 136 in the tunnel 10 is displayed on the partial index bar 120.

In a case where the zoom button 155 is operated and the partial image 137 in the partial image display region 136 is displayed to be enlarged, as shown in FIG. 27, the frame 160 indicating which position of the partial image 137 in the initial display state before enlargement display the portion, which is currently displayed to be enlarged, corresponds to is displayed in the auxiliary window 139.

In a case where the superimposition/superimposition cancellation button 157 is selected, as shown in FIG. 15, the captured image 51 is input to the crack extraction model 96 in the extraction unit 102, and the extracted image 110 is output from the crack extraction model 96. Then, as shown in FIG. 16, the extracted image information 105, which is information of the extracted images 110 for all of the captured images 51, is generated. The extracted image information 105 is output from the extraction unit 102 to the screen distribution control unit 103. Then, as shown in FIG. 28, the extracted image 110 is displayed to be superimposed on the partial image 137 in the partial image display region 136.

In a case where the measurement button 158 is selected and the rectangular region 165 surrounding the object to be measured is designated as shown in FIG. 29 or the plurality of points 167 on the object to be measured are designated as shown in FIG. 30, the display window 166 including the position of the designated object to be measured in the tunnel 10 and the actual size of the designated object to be measured is displayed.

In a case where the display switching buttons 159A and 159B are selected, as shown in FIGS. 31 and 32, the partial image 137 being displayed in the partial image display region 136 is switched to a partial image 137 adjacent to the partial image 137 being displayed in the partial image display region 136.

As described above, the CPU 87B of the inspector terminal 81 comprises the browser control unit 113. The browser control unit 113 performs control to display the partial image display screen 135 on the display 89B. The partial image display screen 135 has the partial index bar 120 and the partial image display region 136. The partial image 137 is displayed in the partial image display region 136. The partial image 137 is an image obtained by imaging the tunnel 10 extending in the length direction LD with the imaging device 12 and is a portion of the long image 55 in which the long side direction is along the length direction LD. The partial index bar 120 extends along the length direction LD and indicates at least a portion of the distance range of the tunnel 10 in the length direction LD. The capture position mark 145 indicating the capture position of the partial image 137 being displayed in the partial image display region 136 in the tunnel 10 is displayed on the partial index bar 120.

The capture position mark 145 enables the inspector UI to recognize which portion of the tunnel 10 the partial image 137 being displayed in the partial image display region 136 corresponds to. Therefore, it is possible to prevent the occurrence of the problem in which it is not possible to specify the position of the tunnel 10 in which deformation, such as the crack 111, has occurred.

The partial image display screen 135 has only the partial index bar 120 and the partial image display region 136 as described above. Therefore, the screen configuration is very simple. In a case where the display region for the long image 55 is provided, a large space is required for the display region. However, in a case where the partial index bar 120 is provided, a large space is not required as compared to the case of the long image 55. In addition, in a case where a structure has a very large length like the tunnel 10 as in the present example, it is difficult to display the structure with the long image 55. However, the partial index bar 120 makes it possible to display the structure even in a case where the length of the structure is large. Therefore, the technology of the present disclosure enables the inspector UI to recognize which portion of the tunnel 10 the partial image 137 being displayed in the partial image display region 136 corresponds to with a simple screen configuration.

As shown in FIG. 25, the browser control unit 113 receives the designation of any position of the partial index bar 120. The browser control unit 113 displays the partial image 137, whose capture position corresponds to the designated position, in the partial image display region 136. This enables the inspector UI to instantly display the desired partial image 137 with a simple operation, which facilitates the inspection of the long image 55.

As shown in FIG. 18 and the like, the inspector terminal 81 can display the whole index bar 118 that indicates a distance range wider than the distance range of the partial index bar 120 and indicates which position in the distance range of the whole index bar 118 the partial index bar 120, which is being displayed, corresponds to. This enables the inspector UI to recognize the position corresponding to the partial index bar 120 which is being displayed.

The distance range indicated by the whole index bar 118 is the entire distance range of the tunnel 10 in the length direction LD. This enables the inspector UI to recognize which position in the entire distance range of the tunnel 10 in the length direction LD the partial index bar 120, which is being displayed, corresponds to. In addition, the distance range indicated by the whole index bar 118 may not be the entire distance range of the tunnel 10 in the length direction LD. For example, half of the distance range of the tunnel 10 in the length direction LD may be indicated by the whole index bar 118.

As shown in FIG. 27, in the inspector terminal 81, the partial image 137 can be displayed to be enlarged in the partial image display region 136. Then, it is possible to display the auxiliary window 139 including the frame 160 indicating which position in the partial image 137 the portion, which is displayed to be enlarged, corresponds to. This enables the inspector UI to recognize which portion of the partial image 137 is displayed to be enlarged.

As shown in FIGS. 26, 31, and 32, the display switching buttons 159A and 159B for inputting an instruction to switch the partial image 137 being displayed in the partial image display region 136 to a partial image 137 adjacent to the partial image 137 being displayed in the partial image display region 136 are provided on the partial image display screen 135. Therefore, it is possible to instantly switch the display of the partial image 137 in the partial image display region 136 with a simple operation, which facilitates the inspection of the long image 55.

As shown in FIG. 20, the inspector terminal 81 can display the portion-of-interest mark, such as the during-imaging designated portion mark 126 indicating the portion of interest of the long image 55, on the partial index bar 120. This enables the inspector UI to recognize where the portion of interest is in the long image 55. The portion of interest is a portion that the inspector UI should inspect with priority and emphasis. Therefore, in a case where the inspector UI can recognize where the portion of interest is, the inspection of the long image 55 is further facilitated.

The portion of interest includes a portion designated by the imaging person UP or the inspector UI, who is the user, and a portion in which the crack 111, which is a specific object, is present. This enables the inspector UI to recognize the portion designated by the imaging person UP or the inspector UI and the portion in which the crack 111 is present.

As shown in FIGS. 21 and 22, the inspector terminal 81 can display the text memo input by the imaging person UP or the inspector UI in association with the portion designated by the imaging person UP or the inspector UI. This enables the inspector UI to easily check the text memo.

The portion designated by the user is a portion designated by the imaging person UP of the long image 55 during the capture of the long image 55 and a portion designated by the inspector UI of the long image 55 during the inspection of the long image 55. This enables the inspector UI to recognize the portion designated by the imaging person UP of the long image 55 during the capture of the long image 55 and the portion designated by the inspector UI of the long image 55 during the inspection of the long image 55.

As shown in FIG. 24, the inspector terminal 81 can display the display completion mark 146 indicating the portion whose partial image 137 is displayed, which makes it possible to display the portion whose partial image 137 is displayed and the portion whose partial image 137 is not displayed to be distinguished from each other on the partial index bar 120. This enables the inspector UI to recognize the portion whose partial image 137 has been displayed and which has been inspected and the portion whose partial image 137 has not been displayed. It is possible to eliminate the double effort of inspecting the portion that has already been inspected without knowing that the portion has already been inspected.

As shown in FIGS. 29 and 30, the browser control unit 113 receives the designation of the object to be measured in the partial image 137. The browser control unit 113 displays the position of the object to be measured in the tunnel 10 and the actual size of the object to be measured in response to the designation. This enables the inspector UI to easily know the position of the object to be measured in the tunnel 10 and the actual size of the object to be measured. In addition, the display target is not limited to both the position of the object to be measured in the tunnel 10 and the actual size of the object to be measured, and at least one of these may be displayed.

As shown in FIG. 6, the long image 55 is an image obtained by combining a plurality of captured images 51 obtained by imaging different portions of the tunnel 10 with the imaging device 12 a plurality of times along at least the length direction LD of the length direction LD and the circumferential direction CD intersecting (orthogonal to) the length direction LD. Therefore, the long image 55 is an image that shows different portions of the inner wall surface 11 of the tunnel 10 along at least the length direction LD and that is suitable for comprehensively inspecting the inner wall surface 11 of the tunnel 10 along the length direction LD. In addition, the “intersection” means that the first direction and the second direction intersect each other at a certain angle and includes something other than “orthogonality” between the length direction LD and the circumferential direction CD described as an example.

As shown in FIGS. 1, 5, and 6, the plurality of captured images 51 are images obtained by imaging the inner wall surface 11 of the tunnel 10 at a plurality of different positions in the length direction LD while moving the imaging device 12 along the length direction LD. Therefore, it is possible to easily obtain a plurality of captured images 51 showing different portions of the inner wall surface 11 of the tunnel 10 along the length direction LD.

In addition, as shown in FIGS. 2 to 4, the imaging device 12 includes a plurality of cameras 27 arranged along the circumferential direction CD. Further, the plurality of captured images 51 are images obtained by imaging the tunnel 10 with the plurality of cameras 27 arranged along the circumferential direction CD. Therefore, it is possible to easily obtain a plurality of captured images 51 showing different portions of the inner wall surface 11 of the tunnel 10 along the circumferential direction CD. In addition, the imaging device 12 includes a plurality of cameras 27 arranged along the length direction LD. Further, the plurality of captured images 51 are images obtained by imaging the tunnel 10 with the plurality of cameras 27 arranged along the length direction LD. Therefore, it is possible to easily obtain a plurality of captured images 51 showing different portions of the inner wall surface 11 of the tunnel 10 along the length direction LD.

More specifically, the imaging device 12 includes a plurality of cameras 27 arranged along the circumferential direction CD. Further, the plurality of captured images 51 are images obtained by imaging the tunnel 10 with the plurality of cameras 27 while moving the imaging device 12 along the length direction LD. The long image 55 is an image obtained by combining the plurality of captured images 51 along the length direction LD and the circumferential direction CD. Therefore, it is possible to easily obtain a plurality of captured images 51 showing different portions of the inner wall surface 11 of the tunnel 10 along the length direction LD and the circumferential direction CD. In addition, the long image 55 is an image that shows different portions of the inner wall surface 11 of the tunnel 10 along the length direction LD and the circumferential direction CD and that is suitable for comprehensively inspecting the inner wall surface 11 of the tunnel 10 along the length direction LD and the circumferential direction CD.

The structure is the tunnel 10, the first direction is the length direction LD connecting the entrance 13 and the exit 14 of the tunnel 10, and the second direction is the circumferential direction CD of the tunnel 10. This makes it possible to comprehensively inspect the inner wall surface 11 of the tunnel 10.

On the partial image display screen 135, the during-inspection designated portion mark 127 may be displayed not only in the portion designated by the inspector UI in the past but also in the portion designated by the inspector UI who is viewing the partial image display screen 135.

The partial image 137 displayed in the partial image display region 136 may be an image in a distance range obtained by giving a slight margin of ±10 m to a preset distance range of 50 m. In this case, the adjacent partial image 137 whose display is switched in response to the selection of the display switching buttons 159A and 159B is also an image in the distance range with a slight margin. For example, in a case where the display switching button 159B is selected while the partial image 137 in a distance range of 190 m to 260 m (a distance range of 200 m to 250 m without margin) is being displayed in the partial image display region 136, the display is switched to the partial image 137 in a distance range of 240 m to 310 m (a distance range of 250 m to 300 m without margin). In this case, the partial image 137 in the distance range of 240 m to 310 m is an example of the “adjacent partial image” according to the technology of the present disclosure.

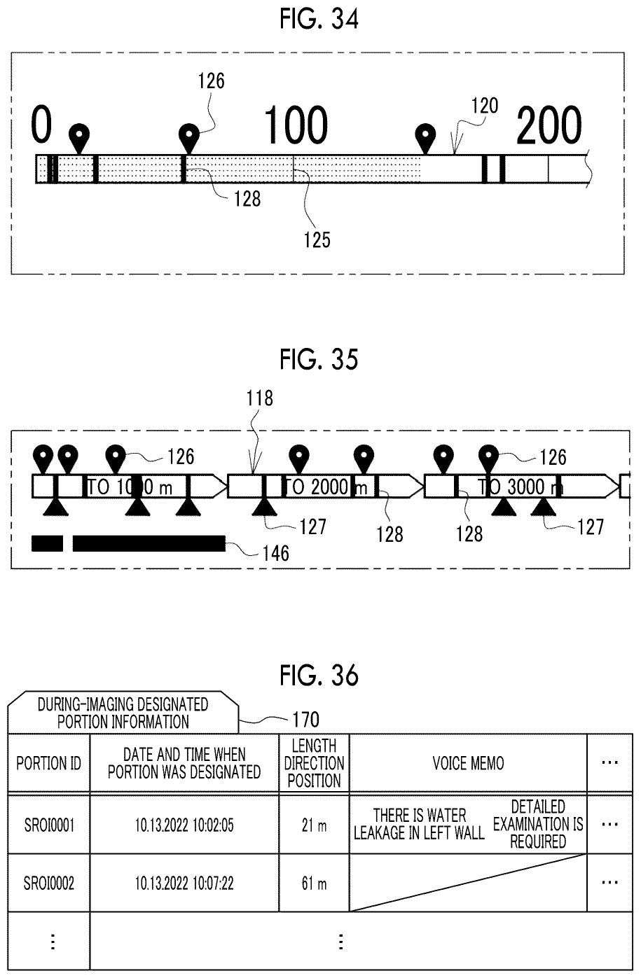

A method of displaying the portion whose partial image 137 is displayed and the portion whose partial image 137 is not displayed to be distinguished from each other is not limited to the display completion mark 146 described as an example. As an example, as shown by hatching in FIG. 34, in the partial index bar 120, the portion whose partial image 137 is displayed may be displayed in at least one of brightness, color, or pattern different from that of the portion whose partial image 137 is not displayed such that the portions are distinguished from each other. This display method also enables the inspector UI to recognize the portion whose partial image 137 has been displayed and which has been inspected and the portion whose partial image 137 has not been displayed, and can eliminate the double effort of inspecting the portion that has already been inspected without knowing that the portion has already been inspected.

In addition, as shown in FIG. 35 as an example, the during-imaging designated portion mark 126, the during-inspection designated portion mark 127, the crack presence portion mark 128, and the display completion mark 146 may be displayed not only on the partial index bar 120 but also on the whole index bar 118.

The memo to be recorded in association with the portion designated by the imaging person UP is not limited to the text memo described as an example. As an example, instead of the text memo, a voice memo may be recorded as in during-imaging designated portion information 170 shown in FIG. 36. In a case where the during-imaging designated portion mark 126 of the partial index bar 120 is selected, the voice memo is reproduced and displayed from a speaker. In addition, the memo to be recorded in association with the portion designated by the inspector UI may also be a voice memo, which is not shown. In short, the memo to be recorded in association with the portion designated by the imaging person UP or the inspector UI may be at least one of a text memo or a voice memo.

Instead of imaging and inspecting the entire inner wall surface 11 of the tunnel 10, a portion of the inner wall surface 11, such as the right surface, the left surface, or the ceiling, may be imaged and inspected. In addition, the road surface 15 may be imaged and inspected in addition to the inner wall surface 11.

The specific object to be extracted is not limited to the crack 111 described as an example. Other deformations, such as peeling, rust, water leakage, or exposure of reinforcing bars, may be extracted. A plurality of types of deformations may be extracted, and the extracted images of the plurality of types of deformations may be displayed to be selectively superimposed on the partial image 137 in response to the operation of the superimposition/superimposition cancellation button 157. In addition, the specific object to be extracted is not limited to the deformation. Further, the specific object to be extracted may be illumination lamps, ventilation ports, or the like arranged at regular intervals in the tunnel 10.

The structure is not limited to the tunnel 10. The structure may be a dam, a bridge, a levee, a public facility, or the like. The imaging device 12 may also be a flying object such as a drone. In the case of the dam, for example, a width direction of a dam body is the first direction, and a height direction thereof is the second direction. In the case of the bridge, for example, a length direction of a bridge girder is the first direction, and a height direction thereof is the second direction.

A hardware configuration of the computer constituting the information management server 80 can be modified in various ways. For example, the information management server 80 can be configured by a plurality of computers separated as hardware for the purpose of improving processing capability and reliability. Specifically, the functions of the acquisition unit 100 and the RW control unit 101 and the functions of the extraction unit 102 and the screen distribution control unit 103 are distributed to two server computers. In this case, the information management server 80 is configured by two server computers. In addition, some or all of the functions of the information management server 80 may be assigned to the inspector terminal 81.

As described above, the hardware configuration of the computer can be appropriately changed according to the required performance, such as processing capability, security, and reliability. It is needless to say that not only the hardware but also the AP, such as the operation program 95, can be duplicated or distributed and stored in a plurality of storage devices for the purpose of ensuring safety and reliability.

The installation portion and operation entity of the information management server 80 may be a data center operated by a company different from the inspection company of the structure or may be one of a plurality of inspection companies.

In the above-described embodiment, for example, the following various processors can be used as a hardware structure of processing units that execute various processes such as the acquisition unit 100, the RW control unit 101, the extraction unit 102, the screen distribution control unit 103, and the browser control unit 113. The various processors include, for example, the CPUs 87A and 87B which are general-purpose processors executing software (the operation program 95 and the inspection AP 112) to function as various processing units as described above, a programmable logic device (PLD), such as a field programmable gate array (FPGA), which is a processor whose circuit configuration can be changed after manufacture, and a dedicated electric circuit, such as an application specific integrated circuit (ASIC), which is a processor having a dedicated circuit configuration designed to perform a specific process.

One processing unit may be configured by one of the various processors or by a combination of two or more processors of the same type or different types (for example, a combination of a plurality of FPGAs and/or a combination of a CPU and an FPGA). In addition, a plurality of processing units may be configured by one processor.

A first example of the configuration in which a plurality of processing units are configured by one processor is an aspect in which one processor is configured by a combination of one or more CPUs and software and functions as a plurality of processing units. A representative example of this aspect is a client computer or a server computer. A second example of the configuration is an aspect in which a processor that implements the functions of the entire system including a plurality of processing units using one integrated circuit (IC) chip is used. A representative example of this aspect is a system on chip (SoC). As described above, various processing units are configured by using one or more of the various processors as the hardware structure.

In addition, more specifically, an electric circuit (circuitry) in which circuit elements, such as semiconductor elements, are combined can be used as the hardware structure of these various processors.

It is possible to understand the techniques described in the following supplementary notes from the above description.

### Supplementary Note 1

An image display device comprising:
a processor,
wherein the processor is configured to:
perform control to display, on a display, a display screen having a display region for a partial image that is a portion of a long image, which is obtained by imaging a structure extending in a first direction with an imaging device and in which a long side direction is along the first direction, and a first index bar which extends in the first direction and indicates a first distance range that is at least a portion of a distance range of the structure in the first direction and on which a capture position mark indicating a capture position of the partial image, which is being displayed in the display region, in the structure is displayed.

### Supplementary Note 2

The image display device according to Supplementary Note 1,
wherein the processor is configured to:
receive a designation of any position of the first index bar; and
display the partial image, whose capture position corresponds to the designated position, in the display region.

### Supplementary Note 3

The image display device according to Supplementary Note 1 or 2,
wherein a second index bar that indicates a second distance range wider than the first distance range and indicates which position in the second distance range the first index bar being displayed corresponds to is capable of being displayed.

### Supplementary Note 4

The image display device according to Supplementary Note 3,
wherein the second distance range is an entire distance range of the structure in the first direction.

### Supplementary Note 5

The image display device according to any one of Supplementary Notes 1 to 4,
wherein the partial image is capable of being displayed to be enlarged in the display region, and
an auxiliary window indicating which position of the partial image the portion displayed to be enlarged corresponds to is capable of being displayed.

### Supplementary Note 6

The image display device according to any one of Supplementary Notes 1 to 5,
wherein an operation portion for inputting an instruction to switch the partial image being displayed in the display region to a partial image adjacent to the partial image being displayed in the display region is provided on the display screen.

### Supplementary Note 7

The image display device according to any one of Supplementary Notes 1 to 6,
wherein a portion-of-interest mark indicating a portion of interest in the long image is capable of being displayed on the first index bar.

### Supplementary Note 8

The image display device according to Supplementary Note 7,
wherein the portion of interest includes at least one of a portion designated by a user or a portion in which a specific object is present.

### Supplementary Note 9

The image display device according to Supplementary Note 8,
wherein a text memo or a voice memo input by the user is displayed in association with the portion of interest.

### Supplementary Note 10

The image display device according to Supplementary Note 8 or 9,
wherein the portion designated by the user is at least one of a portion designated by an imaging person of the long image during capture of the long image or a portion designated by an inspector of the long image during inspection of the long image.

### Supplementary Note 11

The image display device according to any one of Supplementary Notes 1 to 10,
wherein a portion whose partial image is displayed and a portion whose partial image is not displayed are capable of being displayed to be distinguished from each other on the first index bar.

### Supplementary Note 12

The image display device according to Supplementary Note 11,
wherein a display completion mark indicating the portion whose partial image is displayed is displayed on the first index bar such that the portion whose partial image is displayed and the whose partial image is not displayed are displayed to be distinguished from each other.

### Supplementary Note 13

The image display device according to Supplementary Note 11,
wherein at least one of a brightness, color, or pattern of the first index bar is changed such that the portion whose partial image is displayed and the portion whose partial image is not displayed are displayed to be distinguished from each other.

### Supplementary Note 14

The image display device according to any one of Supplementary Notes 1 to 13,
wherein the processor is configured to:
receive a designation of an object to be measured in the partial image; and
display at least one of a position of the object to be measured in the structure or an actual size of the object to be measured in response to the designation.

### Supplementary Note 15

The image display device according to any one of Supplementary Notes 1 to 14,
wherein the long image is an image obtained by combining a plurality of captured images obtained by imaging different portions of the structure with the imaging device a plurality of times along at least the first direction, of the first direction and a second direction intersecting the first direction.

### Supplementary Note 16

The image display device according to Supplementary Note 15,
wherein the plurality of captured images are images obtained by imaging the structure at a plurality of different positions in the first direction while moving the imaging device in the first direction.

### Supplementary Note 17

The image display device according to Supplementary Note 15 or 16,
wherein the imaging device has a plurality of cameras that are arranged along the second direction, and
the plurality of captured images are images obtained by imaging the structure with the plurality of cameras.

### Supplementary Note 18

The image display device according to Supplementary Note 17,
wherein the imaging device has a plurality of cameras that are arranged along the first direction, and
the plurality of captured images are images obtained by imaging the structure with the plurality of cameras.

### Supplementary Note 19

The image display device according to any one of Supplementary Notes 15 to 18,
wherein the imaging device has a plurality of cameras that are arranged along the second direction,
the plurality of captured images are images obtained by imaging the structure with the plurality of cameras while moving the imaging device along the first direction, and
the long image is an image obtained by combining the plurality of captured images along the first direction and the second direction.

### Supplementary Note 20

The image display device according to any one of Supplementary Notes 15 to 19,
wherein the structure is a tunnel,
the first direction is a length direction connecting an entrance and an exit of the tunnel, and
the second direction is a circumferential direction of the tunnel.

In the technology of the present disclosure, the above-described various embodiments and/or various modification examples can be combined with each other as appropriate. In addition, the present disclosure is not limited to the above-described embodiments, and various configurations can be adopted without departing from the gist of the present disclosure. Furthermore, the technology of the present disclosure extends to a storage medium that stores a program in a non-transitory manner, in addition to the program.

The above descriptions and illustrations are detailed descriptions of portions related to the technology of the present disclosure and are only examples of the technology of the present disclosure. For example, the above description of the configurations, functions, operations, and effects is the description of examples of the configurations, functions, operations, and effects of the portions related to the technology of the present disclosure. Therefore, unnecessary portions may be deleted or new elements may be added or replaced in the above descriptions and illustrations without departing from the gist of the technology of the present disclosure. In addition, in the above descriptions and illustrations, the description of, for example, common technical knowledge that does not need to be particularly described to enable the implementation of the technology of the present disclosure is omitted in order to avoid confusion and facilitate the understanding of portions related to the technology of the present disclosure.

In the specification, “A and/or B” is synonymous with “at least one of A or B”. That is, “A and/or B” means only A, only B, or a combination of A and B. Further, in the present specification, the same concept as “A and/or B” is applied to a case where the connection of three or more matters is expressed by “and/or”.

All of the publications, the patent applications, and the technical standards described in the specification are incorporated by reference herein to the same extent as each individual document, each patent application, and each technical standard are specifically and individually stated to be incorporated by reference.

What is claimed is:

1. An image display device comprising:
a processor,
wherein the processor is configured to:
perform control to display, on a display, a display screen having a display region for a partial image that is a portion of a long image, which is obtained by imaging a structure extending in a first direction with an imaging device and in which a long side direction is along the first direction, and a first index bar which extends in the first direction and indicates a first distance range that is at least a portion of a distance range of the structure in the first direction and on which a capture position mark indicating a capture position of the partial image, which is being displayed in the display region, in the structure is displayed.

2. The image display device according to claim 1,
wherein the processor is configured to:
receive a designation of any position of the first index bar; and
display the partial image, whose capture position corresponds to the designated position, in the display region.

3. The image display device according to claim 1,
wherein a second index bar that indicates a second distance range wider than the first distance range and indicates which position in the second distance range the first index bar being displayed corresponds to is capable of being displayed.

4. The image display device according to claim 3,
wherein the second distance range is an entire distance range of the structure in the first direction.

5. The image display device according to claim 1,
wherein the partial image is capable of being displayed to be enlarged in the display region, and
an auxiliary window indicating which position of the partial image the portion displayed to be enlarged corresponds to is capable of being displayed.

6. The image display device according to claim 1,
wherein an operation portion for inputting an instruction to switch the partial image being displayed in the display region to a partial image adjacent to the partial image being displayed in the display region is provided on the display screen.

7. The image display device according to claim 1,
wherein a portion-of-interest mark indicating a portion of interest in the long image is capable of being displayed on the first index bar.

8. The image display device according to claim 7,
wherein the portion of interest includes at least one of a portion designated by a user or a portion in which a specific object is present.

9. The image display device according to claim 8,
wherein a text memo or a voice memo input by the user is displayed in association with the portion of interest.

10. The image display device according to claim 8,
wherein the portion designated by the user is at least one of a portion designated by an imaging person of the long image during capture of the long image or a portion designated by an inspector of the long image during inspection of the long image.

11. The image display device according to claim 1,
wherein a portion whose partial image is displayed and a portion whose partial image is not displayed are capable of being displayed to be distinguished from each other on the first index bar.

12. The image display device according to claim 11,
wherein a display completion mark indicating the portion whose partial image is displayed is displayed on the first index bar such that the portion whose partial image is displayed and the portion whose partial image is not displayed are displayed to be distinguished from each other.

13. The image display device according to claim 11,
wherein at least one of a brightness, color, or pattern of the first index bar is changed such that the portion whose partial image is displayed and the portion whose partial image is not displayed are displayed to be distinguished from each other.

14. The image display device according to claim 1,
wherein the processor is configured to:
receive a designation of an object to be measured in the partial image; and
display at least one of a position of the object to be measured in the structure or an actual size of the object to be measured in response to the designation.

15. The image display device according to claim 1,
wherein the long image is an image obtained by combining a plurality of captured images obtained by imaging different portions of the structure with the imaging device a plurality of times along at least the first direction of the first direction and a second direction intersecting the first direction.

16. The image display device according to claim 15,
wherein the plurality of captured images are images obtained by imaging the structure at a plurality of different positions in the first direction while moving the imaging device in the first direction.

17. The image display device according to claim 15,
wherein the imaging device has a plurality of cameras that are arranged along the second direction, and
the plurality of captured images are images obtained by imaging the structure with the plurality of cameras.

18. The image display device according to claim 17,
wherein the imaging device has a plurality of cameras that are arranged along the first direction, and
the plurality of captured images are images obtained by imaging the structure with the plurality of cameras.

19. The image display device according to claim 15,
wherein the imaging device has a plurality of cameras that are arranged along the second direction,
the plurality of captured images are images obtained by imaging the structure with the plurality of cameras while moving the imaging device along the first direction, and
the long image is an image obtained by combining the plurality of captured images along the first direction and the second direction.

20. The image display device according to claim 15,
wherein the structure is a tunnel,
the first direction is a length direction connecting an entrance and an exit of the tunnel, and
the second direction is a circumferential direction of the tunnel.

21. A method for operating an image display device, the method comprising:
performing control to display, on a display, a display screen having a display region for a partial image that is a portion of a long image, which is obtained by imaging a structure extending in a first direction with an imaging device and in which a long side direction is along the first direction, and a first index bar which extends in the first direction and indicates a first distance range that is at least a portion of a distance range of the structure in the first direction and on which a capture position mark indicating a capture position of the partial image, which is being displayed in the display region, in the structure is displayed.

22. A non-transitory computer-readable storage medium storing a program for operating an image display device, the program causing a computer to execute a process comprising:
performing control to display, on a display, a display screen having a display region for a partial image that is a portion of a long image, which is obtained by imaging a structure extending in a first direction with an imaging device and in which a long side direction is along the first direction, and a first index bar which extends in the first direction and indicates a first distance range that is at least a portion of a distance range of the structure in the first direction and on which a capture position mark indicating a capture position of the partial image, which is being displayed in the display region, in the structure is displayed.
